(19) United States
(12) Patent Application Publication
(10) Pub. No.: US 2023/0069201 A1
(43) Pub. Date: Mar. 2, 2023

(54) USE OF MULTIPLE STEERING MECHANISMS IN SCANNING

(71) Applicant: SiLC Technologies, Inc., Monrovia, CA (US)

(72) Inventors: Mehdi Asghari, La Canada Flintridge, CA (US); Nirmal Warke, Saratoga, CA (US); Prakash Koonath, La Crescenta, CA (US); Bradley Jonathan Luff, La Canada Flintridge, CA (US)

(21) Appl. No.: 17/465,835

(22) Filed: Sep. 2, 2021

(51) Int. Cl. G01S 7/481; G01S 17/58; G01S 17/06

(52) U.S. Cl. CPC G01S 7/4817; G01S 17/58; G01S 17/06

(57) ABSTRACT

A LIDAR system has a beam steering mechanism and a signal steering mechanism that are each configured to steer within a field of view a system output signal that is output from the LIDAR system. A path of system output signal in the field of view has a contribution from the beam steering mechanism and the second mechanism. The contribution of the beam steering mechanism to the path is movement of the system output signal on a two-dimensional path back and forth across the field of view. The contribution of the signal steering mechanism to the path is movement of the system output signal transverse to the two-dimensional path contribution of the provided by the beam steering mechanism.

### FIELD

The invention relates to optical devices. In particular, the invention relates to LIDAR systems.

### BACKGROUND

There is an increasing commercial demand for LIDAR systems that can be deployed in applications such as ADAS (Advanced Driver Assistance Systems) and AR (Augmented Reality). However, LIDAR systems typically use moving mirrors to scan a system output signal from one location to another location in a field of view. The system output signal is generally scanned in a zigzag pattern across the field of view. The LIDAR system generates LIDAR data (radial velocity and/or distance between a LIDAR system and an object external to the LIDAR system) for sample regions that are periodically positioned in the along the path that the system output signal travels in the field of view.

In order to have reliable LIDAR data for the entire field of view, it is desirable for the density of sample regions in the field of view's vertical direction to be about the same as the density of sample regions in the field of view's horizontal direction. However, many LIDAR system applications have a field of view where this result can only be achieved by increasing the scanning speed of the mirror beyond the practical limits of the mirror. As a result, there is a need for LIDAR systems with improved scanning capabilities.

### SUMMARY

A LIDAR system has a beam steering mechanism and a signal steering mechanism that are each configured to steer within a field of view a system output signal that is output from the LIDAR system. A path of system output signal in the field of view has a contribution from the beam steering mechanism and the signal steering mechanism. The contribution of the beam steering mechanism to the path is movement of the system output signal on a two-dimensional path back and forth across the field of view. The contribution of the signal steering mechanism to the path is movement of the system output signal transverse to the two-dimensional path contribution provided by the beam steering mechanism.

A LIDAR system has a signal steering mechanism that steers within a field of view a system output signal that is output from the LIDAR system. The signal steering mechanism includes multiple utility waveguides that are each configured to output a LIDAR output signal. The signal steering mechanism also includes a redirection component configured to output a component output signal that includes light from the LIDAR output signal. A direction that the component output signal travels away from the redirection component changes in response to a change in the utility waveguide that outputs the LIDAR output signal. The LIDAR system also includes a beam steering mechanism configured to steer the system output signal on a two-dimensional path in the field of view.

A LIDAR system has a signal steering mechanism that steers within a field of view a system output signal that is output from the LIDAR system. The signal steering mechanism includes multiple utility waveguides that are each configured to guide a utility light signal and to output a LIDAR output signal that includes light from the utility light signal. Each of the utility waveguides includes an amplifier configured to amplify a power level of the utility light signal guided in the utility waveguide. A redirection component is configured to output a component input signal that includes light from the LIDAR output signal. The direction that the component output signal travels away from the redirection component changes in response to a change in which one of the amplifiers amplifies one of the utility light signals.

A LIDAR system is configured to output multiple different system output signals that each travels away from the LIDAR system in a different direction. The LIDAR system is also configured to receive system return signals that each carries light from a different one of the system output signals. The LIDAR system is configured to combine light from each of the system return signals with a reference signal so as to generate a signal beating at a beat frequency. The LIDAR system also includes electronics that have an electrical demulitplexer that receives multiple different electrical data signals. Each of the data signals indicates a different one of the beat frequencies. The electronics select a portion of the data signals and operate the electrical demultiplexer such that the electrical demulitplexer outputs the selected portion of the data signals. The electronics include a LIDAR data generator configured to calculate LIDAR data from the beat frequency indicated by the selected portion of data signals.

### BRIEF DESCRIPTION OF THE FIGURES

FIG. 1 is a top view of a LIDAR chip that is suitable for use with a LIDAR adapter.

FIG. 2 is a top view of a LIDAR chip that is suitable for use with a LIDAR adapter.

FIG. 3A is a top view of a portion of a LIDAR system having a LIDAR adapter in optical communication with a LIDAR chip. A pathway that light signals carrying channel C₂ travel from the LIDAR chip, through the LIDAR adapter, and then out of the LIDAR system is illustrated.

FIG. 3B is the LIDAR system of FIG. 3A. A pathway that light signals carrying channel C₂ travel from outside of the LIDAR system, through the LIDAR adapter, and into the LIDAR chip is illustrated.

FIG. 3C is the LIDAR system of FIG. 3A. A pathway that light signals carrying channel C₃ travel travels through the LIDAR system is illustrated.

FIG. 4 is a topview of a LIDAR system that includes the LIDAR chip and electronics of FIG. 2 and the LIDAR adapter of FIG. 3 on a common support.

FIG. 5A is a schematic of the relationship between a LIDAR system and the field of view.

FIG. 5B is a sideview of a plane shown in FIG. 5A.

FIG. 5C is another sideview of the imaginary plane from FIG. 5A.

FIG. 6A through FIG. 6E illustrate a processing component suitable for use in a LIDAR system. FIG. 6A illustrates an example of an optical-to-electrical assembly suitable for use in the processing component.

FIG. 6B provides a schematic of electronics that are suitable for use with an optical-to-electrical assembly constructed according to FIG. 6A.

FIG. 6C is a graph of frequency versus time for a LIDAR output signal.

FIG. 6D is a schematic of the relationship between sensors in the optical-to-electrical assembly from FIG. 6A and electronics in the LIDAR system.

FIG. 6E is a schematic of another relationship between sensors in the optical-to-electrical assembly from FIG. 6A and electronics in the LIDAR system.

FIG. 7 is a topview of a signal directing component that is suitable for use with a LIDAR system.

FIG. 8 is a topview of another signal directing component that is suitable for use with a LIDAR system.

FIG. 9 is a cross-section of portion of a chip constructed from a silicon-on-insulator wafer.

FIG. 10A is a perspective view of a portion of a LIDAR chip that includes an interface for optically coupling the LIDAR chip with an amplifier.

FIG. 10B is a perspective view of an amplifier chip suitable for use with the portion of the LIDAR chip shown in FIG. 10A.

FIG. 10C and FIG. 10D illustrate system that includes the LIDAR chip of FIG. 10A interfaced with the amplifier of FIG. 10B. FIG. 10C is a topview of the system.

FIG. 10D is a cross section of the system shown in FIG. 10C taken through a waveguide on the LIDAR chip and the amplifier waveguide on the amplifier chip.

FIG. 11 is a perspective view of the amplifier chip of FIG. 10B through FIG. 10D modified to include two amplifier waveguides.

### DESCRIPTION

A LIDAR system includes multiple different steering mechanisms that each steers a system output signal to different samples regions in the LIDAR system's field of view. The LIDAR system generates LIDAR data for the different sample regions. The LIDAR data for a sample region can indicate the radial velocity and/or distance between the LIDAR system and an object(s) in the sample region.

One of the steering mechanisms can be a beam steering mechanism that steers the system output signal back and forth across the field of view. Another one of the steering mechanisms can be a signal steering mechanism that steers the system output signal outside of the path provided by the beam steering mechanism. For instance, the signal steering mechanism can steer the system output signal in a direction that is transverse to the path provided by the beam steering mechanism. Since the signal steering mechanism allows movement of the system output signal off the path provided by the beam steering mechanism, the signal steering mechanism can be used to increase the sample region density in directions transverse to the path provided by the beam steering mechanism. As a result, the uniformity of sample region density across the field of view can be increased without the need to increase the scanning speed provided by the beam steering mechanism to impractical levels.

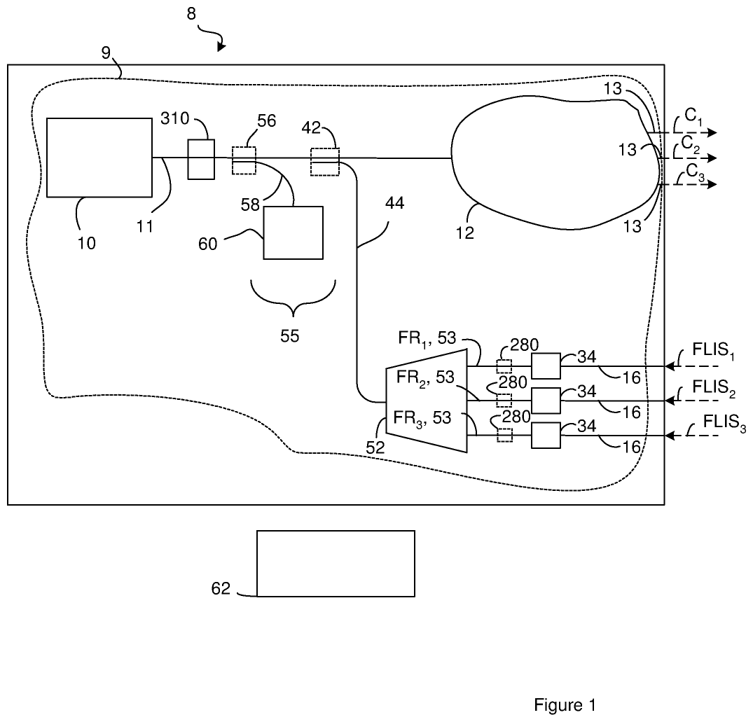

FIG. 1 is a topview of a LIDAR chip 8 that includes chip components 9. The LIDAR chip can include a Photonic Integrated Circuit (PIC) and can be a Photonic Integrated Circuit (PIC) chip. The chip components 9 include a light source 10 that outputs a light source output signal. The light source output signal can carry a preliminary channel associated with a wavelength. Suitable light sources 10 include but are not limited to, semiconductor lasers.

The chip components 9 include a source waveguide 11 that receives the light source output signal from the light source 10. The source waveguide 11 carries the light source output signal to a signal directing component 12. The signal directing component 12 can be operated by electronics so as direct light from the light source output signal to one of multiple different utility waveguides 13. Each of the utility waveguides 13 can receive the light from the signal directing component 12 as an outgoing LIDAR signal. When any of the utility waveguides 13 receives the outgoing LIDAR signals, the utility waveguide 13 carries the outgoing LIDAR signal to an exit port through which the outgoing LIDAR signal can exit from the LIDAR chip and serve as a LIDAR output signal. Examples of suitable exit ports include, but are not limited to, waveguide facets such as the facets of the utility waveguides 13.

FIG. 1 has multiple arrows that each represents a LIDAR output signal traveling away from a utility waveguide 13. Each of the LIDAR output signals is associated with a channel index i=1 through N. For the purposes of illustration, the LIDAR system is shown as generating three LIDAR output signals (N=3) labeled C₁ through C₃. Each of the different LIDAR output signals can represent a different channel. However, each of the different channels can carry the same selections of wavelength(s) or substantially the same selections of wavelength(s). The channel that is output from the LIDAR chip is a function of the utility waveguide 13 that receives the outgoing LIDAR signal from the signal directing component 12. As a result, each of the utility waveguides 13 is associated with the channel index for the LIDAR output signal output from the utility waveguides 13.

Accordingly, the electronics can operate the signal directing component 12 so as to select the LIDAR output signal and channel that is output from the LIDAR chip.

Light from each of the LIDAR output signals can be included in a system output signal that is output from the LIDAR system. The system output signals travel away from the LIDAR system and can each be reflected by an object(s) in the path of the system output signal. Light from a reflected system output signal can return to the LIDAR system as a system return signal.

The LIDAR chip includes multiple first input waveguides 16. Each of the first input waveguides 16 can receive a first LIDAR input signal that includes or consists of light from one of the system return signals. The first LIDAR input signals each carries one of the channels (Cᵢ) and can be represented by FLISᵢ where i is the channel index. The first LIDAR input signal that carries light from the channel C₁ is labeled FLIS_{C1} and is received at one of the first input waveguides 16. The first LIDAR input signal that carries the channel C₃ is labeled FLIS_{C3} and is received at one of the first input waveguides 16.

Each of the first LIDAR input signals enters one of the first input waveguides 16 and serves as a first comparative signal. Each of the first input waveguides 16 carries one of the first comparative signals to a first processing component 34.

The chip components 9 include a splitter 42 configured to move a portion of the light source output signal from the source waveguide 11 onto an intermediate waveguide 44 as a preliminary reference signal. Suitable splitters 42 include, but are not limited to, evanescent optical couplers, y-junctions, and MMIs.

The intermediate waveguide 44 carries the preliminary reference signal to a reference splitter 52. The reference splitter 52 is configured to divide the preliminary reference signal into first reference signals that are each received at a different one of multiple first reference waveguides 53. The reference splitter 52 can be a wavelength independent splitter such as an optical coupler, y-junction, MMI, cascaded evanescent optical couplers, or cascaded y-junctions. As a result, the LIDAR output signals can each have the same, or about the same, distribution of wavelengths. For instance, the reference splitter 52 can be configured such that each of the first reference signals carries the same or substantially the same selection of wavelengths.

Each of the first reference waveguides 53 guides one of the first reference signals to one of the processing components 34. The first reference waveguide 53 and the first input waveguides 16 are arranged such that each processing component 34 receives a first reference signal and a first LIDAR input signal. The LIDAR system is configured to use the first reference signal and the first LIDAR input signal received at a processing component 34 to generate LIDAR data.

The LIDAR chip can include a control branch 55 for controlling operation of the light source 10. The control branch 55 includes a directional coupler 56 that moves a portion of the source output signal from the source waveguide 11 onto a control waveguide 58. The coupled portion of the source output signal serves as a tapped signal. Although FIG. 1 illustrates a directional coupler 56 moving a portion of the source output signal onto the control waveguide 58, other signal-tapping components can be used to move a portion of the source output signal from the utility waveguide 12 onto the control waveguide 58. Examples of suitable signal tapping components include, but are not limited to, y-junctions, and MMIs.

The control waveguide 58 carries the tapped signal to control components 60. The control components 60 can be in electrical communication with electronics 62. During operation, the electronics 62 can adjust the frequency of the source output signal in response to output from the control components. An example of a suitable construction of control components is provided in U.S. patent application Ser. No. 15/977,957, filed on 11 May 2018, entitled “Optical Sensor Chip,” and in U.S. patent application Ser. No. 17/351,170, filed on 17 Jun. 2021, entitled “Scanning Multiple LIDAR System Output Signals,” each of which is incorporated herein in its entirety.

The intermediate waveguide 44 and reference splitter 52 can be optional. For instance, multiple splitters 42 can be positioned along the source waveguide 11 and each of the first reference waveguides 53 can receive a portion of the light source output signal carried on the source waveguide 11 from a different one of the reference splitters 42. The portion of the light source output signal received on each of the first reference waveguides 53 can serve as a different one of the first reference signals that the first reference waveguide 53 guides to a processing component 34.

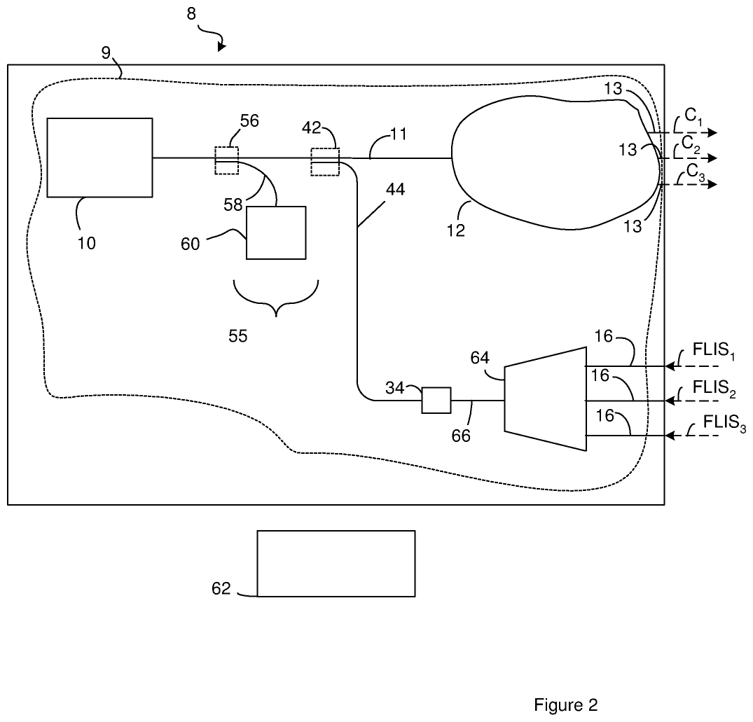

The LIDAR chip can be modified to include a single processing component 34. For instance, FIG. 2 is a topview of a LIDAR chip where each of the first input waveguides 16 carries the received first LIDAR input signals to a second signal directing component 64. The second signal directing component 64 can be a signal combiner that directs the first LIDAR input signals carried on different first input waveguides 16 to a common waveguide 66. The common waveguide 66 can carry the received first LIDAR input signals to a processing component 34. Additionally, the preliminary reference signal carried on the intermediate waveguide 44 can serve as a first reference signal that the intermediate waveguide 44 carries to the processing component 34. As a result, the processing component 34 receives a first reference signal and a first LIDAR input signal. The LIDAR system is configured to use the first reference signal and the first LIDAR input signal received at a processing component 34 to generate LIDAR data.

The LIDAR chips can be used in conjunction with a LIDAR adapter. In some instances, the LIDAR adapter can be optically positioned between the LIDAR chip and the one or more reflecting objects and/or the field of view in that an optical path that the LIDAR output signals travel from the LIDAR chip to the field of view passes through the LIDAR adapter. Additionally, the LIDAR adapter can be configured such that the LIDAR output signals, the first LIDAR input signals and the second LIDAR input signals travel on different optical pathways between the LIDAR adapter and the reflecting object(s).

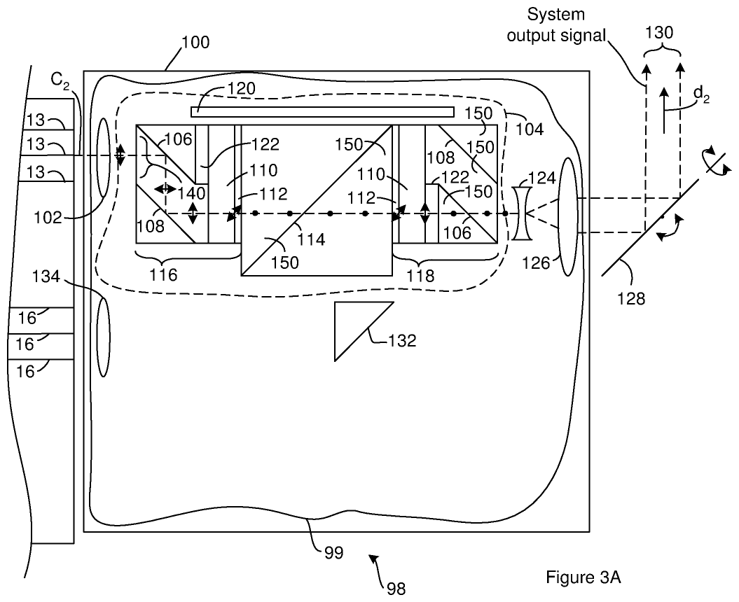

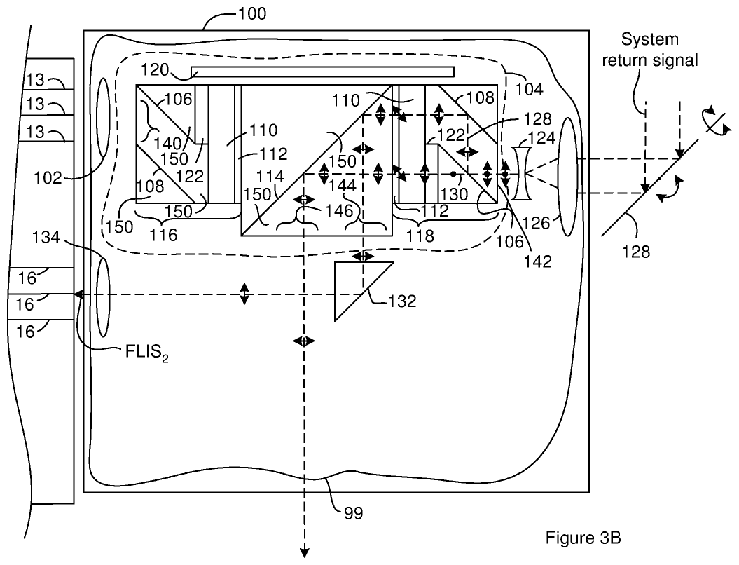

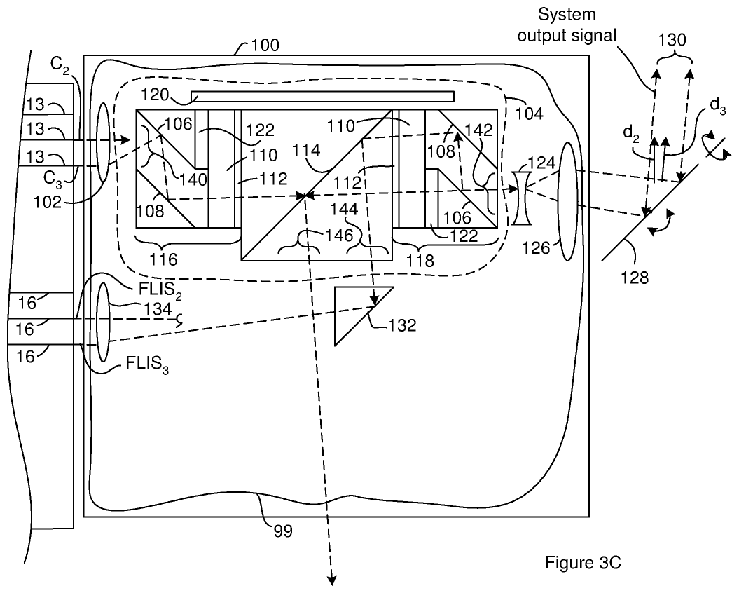

An example of a LIDAR adapter that is suitable for use with the LIDAR chip of FIG. 1 and FIG. 2 is illustrated in FIG. 3A and FIG. 3B. A path of the light signals that carry the channel C₂ is shown in FIG. 3A and FIG. 3B. The path shown in FIG. 3A follows light from the LIDAR output signal carrying channel C₂ traveling from the LIDAR chip through the adapter until it exits the LIDAR system as a system output signal. In contrast, FIG. 3B follows light from the system return signals carrying channel C₂ traveling through the adapter until it enters the LIDAR chip in a first LIDAR input signal and a second LIDAR input signal.

The LIDAR adapter 98 includes multiple adapter components 99 positioned on a base 100. The adapter components 99 include a redirection component 102 positioned to receive a component input signal that includes or consists of light from the LIDAR output signals. For instance, the redirection component 102 can be positioned to receive the LIDAR output signal carrying channel C₂ from the LIDAR chip as illustrated in FIG. 3A. The redirection component 102 is configured to output a component output signal that can serve as a circulator input signal. As will be described in more detail below, the adapter components 99 can include a circulator 104 and the redirection component 102 can be configured to output circulator input signals that can enter the circulator traveling in different non-parallel directions. Additionally or alternately, the redirection component 102 can be configured such that the circulator input signals are focused or collimated at a desired location. For instance, the redirection component 102 can be configured to focus or collimate the circulator input signal at a desired location on the circulator 104. The illustrated redirection component 102 is a lens.

The circulator 104 can include a first polarization beam splitter 106 that receives the circulator input signal. The first polarization beam splitter 106 is configured to split the circulator input signal into a light signal in a first polarization state and a light signal in a second polarization state signal. The first polarization state and the second polarization state can be linear polarization states and the second polarization state is different from the first polarization state. For instance, the first polarization state can be TE and the second polarization state can be TM or the first polarization state can be TM and the second polarization state can be TE.

Because the light source 10 often includes a laser as the source of the light source output signal, the light source output signal can be linearly polarized. Since the light source output signal is the source of the circulator input signals, the circulator input signals received by the first polarization beam splitter 106 can also be linearly polarized. In FIG. 3A and FIG. 3B, light signals with the first polarization state are labeled with vertical bi-directional arrows and light signals with the polarization state are labeled filled circles. For the purposes of the following discussion, the circulator input signals are assumed to be in the first polarization state, however, the circulator input signals in the second polarization state are also possible. Since the circulator input signals are assumed to be in the first polarization state, the circulator input signals are labeled with vertical arrows.

Since the circulator input signals are assumed to be in the first polarization state, the first polarization beam splitter 106 is shown outputting a first polarization state signal in the first polarization state. However, the first polarization beam splitter 106 is not shown outputting a light signal in the second polarization state due to a lack of a substantial amount of the second polarization state in the circulator input signals.

The circulator 104 can include a second polarization beam splitter 108 that receives the first polarization state signal. The second polarization beam splitter 108 splits the first polarization state signal into a first polarization signal and a second polarization signal where the first polarization signal has a first polarization state but does not have, or does not substantially have, a second polarization state and the second polarization signal has the second polarization state but does not have, or does not substantially have, the first polarization state. Since the first polarization state signal received by the second polarization beam splitter 108 has the first polarization state but does not have, or does not substantially have, the second polarization state; the second polarization beam splitter 108 outputs the first polarization signal but does not substantially output the second polarization signal. The first polarization beam splitter 106 and the second polarization beam splitter 108 can have the combined effect of filtering one of the polarization states from the circulator input signals.

The circulator 104 can include a non-reciprocal polarization rotator 110 that receive the first polarization signal and outputs a first rotated signal. In some instances, the non-reciprocal polarization rotator 110 is configured to rotate the polarization state of the first polarization signal by n*90°+45° where n is 0 or an even integer. As a result, the polarization state of the first rotated signal is rotated by 45° from the polarization state of the first polarization signal. Suitable non-reciprocal polarization rotators 110 include, but are not limited to, non-reciprocal polarization rotators such as Faraday rotators.

The circulator 104 can include a 45° polarization rotator 112 that receives the first rotated signal and outputs a second rotated signal. In some instances, the 45° polarization rotator 112 is configured to rotate the polarization state of the first rotated signal by m*90°+45° where m is 0 or an even integer. As a result, the polarization state of the second rotated signal is rotated by 45° from the polarization state of the first rotated signal. The combined effect of the polarization state rotations provided by the non-reciprocal polarization rotator 110 and the 45° polarization rotator 112 is that the polarization state of the second rotated signal is rotated by 90° relative to the polarization state of the first polarization signal. Accordingly, in the illustrated example, the second rotated signal has the second polarization state. Suitable 45° polarization rotators 112 include, but are not limited to, reciprocal polarization rotators such as half wave plates.

The circulator 104 can include a third polarization beam splitter 114 that receives the second rotated signal from the 45° polarization rotator 112. The third polarization beam splitter 114 is configured to split the second rotated signal into a light signal in the first polarization state and a light signal in the second polarization state signal. Since the second rotated signal is in the second polarization state, the third polarization beam splitter 108 outputs the second rotated signal but does not substantially output a signal in the first polarization state.

As is evident from FIG. 3A, the first polarization beam splitter 106, the second polarization beam splitter 108, the non-reciprocal polarization rotator 110, and the 45° polarization rotator 112 can be included in a component assembly 116. The component assembly 116 can be constructed as a monolithic block in that the components of the component assembly 116 can be bonded together in a block. In some instances, the component assembly 116 has the geometry of a cube, cuboid, square cuboid, or rectangular cuboid.

The circulator 104 can include a second component assembly 118. In some instances, the second component assembly 118 has the same construction as the component assembly 116. As a result, the component assembly 116 can also serve as the second component assembly 118. The second component assembly 118 can receive the second rotated signal from the third polarization beam splitter 108. In particular, the 45° polarization rotator 112 in the second component assembly 118 can receive the second rotated signal from the third polarization beam splitter 108 and output a third rotated signal. In some instances, the 45° polarization rotator 112 is configured to rotate the polarization state of the second rotated signal by m*90°+45° where m is 0 or an even integer. As a result, the polarization state of the third rotated signal is rotated by 45° from the polarization state of the second rotated signal. Suitable 45° polarization rotators 112 include, but are not limited to, reciprocal polarization rotators such as half wave plates.

The second component assembly 118 can include a non-reciprocal polarization rotator 110 that receive the third rotated signal and outputs a fourth rotated signal. In some instances, the non-reciprocal polarization rotator 110 is configured to rotate the polarization state of the third polarization signal by n*90°+45° where n is 0 or an even integer. As a result, the polarization state of the fourth rotated signal is rotated by 45° from the polarization state of the third polarization signal. Suitable non-reciprocal polarization rotators 110 include, but are not limited to, non-reciprocal polarization rotators such as Faraday rotators.

The combined effect of the polarization state rotations provided by the non-reciprocal polarization rotator 110 and the 45° polarization rotator 112 in the second component assembly 118 is that the polarization state of the fourth rotated signal is rotated by 90° relative to the polarization state of the second polarization signal. Accordingly, in the illustrated example, the fourth rotated signal has the first polarization state.

When the non-reciprocal polarization rotator 110 in the first component assembly 116 and the non-reciprocal polarization rotator 110 in the first component assembly 118 are each a Faraday rotator, the adapter components 99 can include a magnet 120 positioned to provide the magnetic field that provides the Faraday rotators with the desired functionality.

The second component assembly 118 can include a 90° polarization rotator 122 that receives the fourth rotated signal and outputs a fifth rotated signal. In some instances, the 90° polarization rotator 122 is configured to rotate the polarization state of the first rotated signal by n*90°+90° where n is 0 or an even integer. As a result, the polarization state of the fifth rotated signal is rotated by 90° from the polarization state of the fourth rotated signal. The combined effect of the polarization state rotations provided by the non-reciprocal polarization rotator 110, the 45° polarization rotator 112, and the 90° polarization rotator 122 is that the polarization state of the fifth rotated signal is rotated by 0° relative to the polarization state of the second rotated signal. Accordingly, in the illustrated example, the fifth rotated signal has the second polarization state. Suitable 90° polarization rotators 122 include, but are not limited to, reciprocal polarization rotators such as half wave plates.

In instances where the second component assembly 118 has the same construction as the component assembly 116, the 90° polarization rotator 122 may also be present in the component assembly 116.

The first polarization beam splitter 106 in the component assembly 116 receives the fifth rotated signal. The first polarization beam splitter 106 is configured to split the received light signal into a light signal with the first polarization state and a light signal with the second polarization state. Because the fifth rotated signal is in the second polarization state and does not have a component, or does not have a substantial component, in the first polarization state, the first polarization beam splitter 106 outputs an outgoing circulator signal having the second polarization state. As illustrated in FIG. 3A, the outgoing circulator signal exits from the circulator.

The adapter components 99 include a beam shaper 124 positioned to receive the outgoing circulator signal. In some instances, the beam shaper 124 is configured to expand the width of the outgoing circulator signal. Suitable beam shapers 124 include, but are not limited to, concave lenses, convex lenses, plano concave lenses, and plano convex lenses.

The adapter components 99 include a collimator 126 that receives the shaped outgoing circulator signal and to output a collimated outgoing circulator signal. Suitable collimators 126 include, but are not limited to, convex lenses and GRIN lenses.

The LIDAR systems of FIG. 3A includes one or more beam steering components 128 that receive the collimated outgoing circulator signal from the collimator 126 and that output the system output signal carrying the channel C₂. The direction that the system output signal carrying channel C₂ travels away from the LIDAR system is labeled d₂ in FIG. 3A. The electronics can operate the one or more beam steering components 128 so as to steer the system output signal to different sample regions 129 in the field of view. As a result, the one or more beam steering components 128 can function as a signal steering mechanism that is operated by the electronics so as to steer the system output signals within the field of view of the LIDAR system. The electronics can operate the signal steering mechanism and the beam steering mechanism independently of one another or in conjunction with one another.

The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

Suitable beam steering components 128 include, but are not limited to, movable mirrors, MEMS mirrors, optical phased arrays (OPAs), optical gratings, and actuated optical gratings.

FIG. 3B shows the path that light from the system return signals carrying channel C₂ travels through the adapter of FIG. 3A until it enters the LIDAR chip in a first LIDAR input signal.

The system return signal is received by the one or more beam steering components 128. The one or more beam steering components 128 output a steered return signal directed to the beam shaper 124. In instances where the beam shaper 124 is configured to expand the width of the outgoing circulator signal, the beam shaper 124 contracts the width of the steered return signal.

The beam shaper 124 outputs a circulator return signal that is received by the oscillator. In particular, the circulator return signal is received by the first polarization beam splitter 106 in the second component assembly 118. As noted above, a possible result of using one or more lasers is the light source 10 is that the system output signals are linearly polarized. For instance, the light carried by the system output signal is all of, or is substantially all of, the first polarization state or the second polarization state. Reflection of the system output signal by an object may change the polarization state of all or a portion of the light in the system output signal. Accordingly, the system return signal can include light of different linear polarization states. For instance, the system return signal can have a first contribution from light in the first polarization state and a second contribution from light in the second polarization state. The first polarization beam splitter 106 can be configured to separate the first contribution and the second contribution. For instance, the first polarization beam splitter 106 can be configured to output a first separated signal 128 that carries light in the first polarization state and a second separated signal 130 that carries light in the second polarization state.

The second polarization beam splitter 108 in the second component assembly 118 receives the first separated signal and reflects the first separated signal. The non-reciprocal polarization rotator 110 in the second component assembly 118 receives the first separated signal and outputs a first FPSS signal. The letters FPSS represent First Polarization State Source and indicate that the light that was in the first polarization state after reflection by the object was the source of the light for the first FPSS signal.

The first separated signal travels through the non-reciprocal polarization rotator 110 in the opposite direction of the third rotated signal. As a result, the non-reciprocal polarization rotator 110 is configured to rotate the polarization state of the first separated signal by −n*90°−45°. Accordingly, the polarization state of the first FPSS signal is rotated by −45° from the polarization state of the first separated signal.

The 45° polarization rotator 112 in the second component assembly 118 receives the first FPSS signal and outputs a second FPSS signal. Because the 45° polarization rotator 112 is a reciprocal polarization rotator, the 45° polarization rotator 112 is configured to rotate the polarization state of the first FPSS signal by m*90°+45° where m is 0 or an even integer. As a result, the polarization state of the second FPSS signal is rotated by 45° from the polarization state of the first FPSS signal. The combined effect of the polarization state rotations provided by the non-reciprocal polarization rotator 110 and the 45° polarization rotator 112 in the second component assembly 118 is that the second FPSS signal has been rotated by 0° from the polarization state of the first separated signal. As a result, the second FPSS signal has the first polarization state.

The second FPSS signal is received at the third polarization beam splitter 114. The third polarization beam splitter 114 reflects the second FPSS signal and the second FPSS signal exits the circulator 104. After exiting the circulator 104, the second FPSS signal is received at a first beam steering component 132 configured to change the direction of travel of the second FPSS signal. Suitable first beam steering components 132 include, but are not limited to, mirrors and right-angled prism reflectors.

The second FPSS signal travels from the first beam steering component 132 to a second lens 134. The second lens 134 is configured to output the first LIDAR input signal represented by FLIS₂. Additionally, the second lens 134 is configured to focus or collimate the first LIDAR input signal (FLIS₂) at a desired location. For instance, the second lens 134 can be configured to focus the first LIDAR input signal (FLIS₂) at an exit port on one of the first input waveguides 16. For instance, the second lens 134 can be configured to focus the first LIDAR input signal (FLIS₂) at a facet of one of the first input waveguides 16 as shown in FIG. 3A.

As described in the context of FIG. 1A and FIG. 1B, the first LIDAR input signal (FLIS₂) enters one of the first input waveguides 16 and serves as a first comparative signal that is guided to one of the first processing components 34.

The 90° polarization rotator 122 in the second component assembly 118 receives the second separated signal 130 and outputs a first SPSS signal. The letters SPSS represent Second Polarization State Source and indicate that the light that was in the second polarization state after reflection by the object was the source of the light for the first SPSS signal. Because the 90° polarization rotator 122 is a reciprocal polarization rotator, the 90° polarization rotator 122 is configured to rotate the polarization state of the second separated signal 130 by n*90°+90° where n is 0 or an even integer. As a result, the polarization state of the first SPSS signal is rotated by 90° from the polarization state of the second separated signal 130. Accordingly, in the illustrated example, the first SPSS signal has the first polarization state.

The non-reciprocal polarization rotator 110 in the second component assembly 118 receives the first SPSS signal and outputs a second SPSS signal. The first SPSS signal travels through the non-reciprocal polarization rotator 110 in the opposite direction of the third rotated signal. As a result, the non-reciprocal polarization rotator 110 is configured to rotate the polarization state of the first SPSS signal by −n*90°−45°. Accordingly, the polarization state of the second SPSS signal is rotated by −45° from the polarization state of the first SPSS signal.

The 45° polarization rotator 112 in the second component assembly 118 receives the second SPSS signal and outputs a third SPSS signal. Because the 45° polarization rotator 112 is a reciprocal polarization rotator, the 45° polarization rotator 112 is configured to rotate the polarization state of the second SPSS signal by m*90°+45° where m is 0 or an even integer. As a result, the polarization state of the third SPSS signal is rotated by 45° from the polarization state of the second FPSS signal. The combined effect of the polarization state rotations provided by the non-reciprocal polarization rotator 110 and the 45° polarization rotator 112 in the second component assembly 118 is that the third SPSS signal has been rotated by 0° from the polarization state of the first SPSS signal. Additionally, the combined effect of the polarization state rotations provided by the non-reciprocal polarization rotator 110, the 45° polarization rotator 112, and the 90° polarization rotator 122 in the second component assembly 118 is that the third SPSS signal has been rotated by 90° from the polarization state of the second separated signal 130. Accordingly, in the illustrated example, the third SPSS signal is shown in the first polarization state.

The third SPSS signal is received at the third polarization beam splitter 114. The third polarization beam splitter 114 reflects the third SPSS signal such that the third SPSS signal exits the circulator 104. After exiting the circulator 104, the third SPSS signal can exit the adapter as shown in FIG. 3B.

FIG. 3C illustrates the path that light from the LIDAR output signal that carries channel C₃ travels through the LIDAR system. The redirection component 102 can be configured such that the light from different LIDAR output signals travel different paths through the circulator. For instance, the redirection component 102 can be configured such that the light from different circulator input signals travel non-parallel paths through the circulator. In some instances, the redirection component 102 is configured such that the different circulator input signals enter a first port of the circulator 104 traveling in different directions. For instance, the illustrated redirection component 102 is a lens that receives the LIDAR output signals. The angle of incidence of the different LIDAR output signals on the lens can be different. For instance, in FIG. 3C, the LIDAR output signal carrying channel C₃ has a different incident angle on the lens than the incident angle of the LIDAR output signal carrying channel C₂. As a result, the circulator input signal carrying channel C₃ and the circulator input signal carrying channel C₂ travel away from the lens in different directions. Because the different circulator input signals travel away from the redirection component 102 in different directions, the LIDAR output signals enter a first port 140 of the circulator 104 traveling in different directions.

Although the different circulator input signals enter the circulator 104 traveling in different directions, the light from the different circulator input signals are processed by the same selection of circulator components in the same sequence. For instance, the light from different circulator input signals travels through components in the sequence disclosed in the context of FIG. 3A and FIG. 3B. As a result, the light from the different circulator input signals exit from the circulator at a second port 142. For instance, the path of the light from the circulator input signal that carries channel C₃ through the circulator shows the outgoing circulator signal exiting from the circulator at a second port 142. Additionally, the light from the circulator return signal that carries channel C₃ enters the circulator at the second port 142. Similarly, the light from the circulator input signal carrying channel C₂ enters and exits the circulator at the second port 142 as described in the context of FIG. 3A and FIG. 3B.

A comparison of FIG. 3A and FIG. 3B shows that outgoing circulator signals approach the second port 142 from different directions and travel away from the circulator in different directions. The difference in the directions of the outgoing circulator signals can result from the circulator input signals entering the circulator from different directions.

FIG. 3C shows light from the outgoing circulator signal that carries channel C₃ exiting the LIDAR system as a system output signal that carries channel C₃. The direction that the system output signal carrying channel C₃ travels away from the LIDAR system is labeled d₃ in FIG. 3C. FIG. 3C also includes the label d₂ from FIG. 3A. The label d₂ illustrates the direction that the system output signal that carries channel C₂ travels away from the LIDAR system. A comparison of the labels d₂ and d₃ shows that the system output signals carrying channel C₂ and C₃ travel away from the LIDAR system in different directions. As a result, different system output signals can illuminate different sample regions. LIDAR data can be generated for each of the different sample regions that are concurrently illuminated by the LIDAR system.

The system output signals that travel away from the LIDAR system in different directions each includes or consists of light from a different one of the LIDAR output signals. Each of the different LIDAR output signals exit from a different one of the utility waveguides 13 on the LIDAR chip. For instance, FIG. 3C shows the LIDAR output signal carrying channel C₃ exiting from a different utility waveguide 13 than the LIDAR output signal carrying channel C₂. The utility waveguides 13 are arranged such that incident angle of the different LIDAR output signals on the lens 102 changes in response to changes to the utility waveguide 13 from which the LIDAR output signals exits. As a result, the direction that the system output signal travels away from the LIDAR system changes in response to changes in the utility waveguide 13 from which the LIDAR output signals exits. For instance, the direction that the system output signal travels away from the LIDAR system is a function of the utility waveguide 13 from which the circulator receives the LIDAR output signal. Accordingly, the electronics can change the direction that the system output signal travels away from the LIDAR system by operating the signal directing component 12 so as to change the utility waveguide 13 from which the LIDAR output signals exits. The system output signals travel away from the LIDAR system in different directions as a result of the different circulator input signals entering the circulator 104 traveling in different directions due to the functionality of the signal directing component 12 and the redirection component 102. As a result, the signal directing component 12 and the redirection component 102 can function as a signal steering mechanism that is operated by the electronics so as to steer the system output signals within the field of view of the LIDAR system.

The system return signal carrying channel C₂ returns to the LIDAR system in the reverse direction of the arrow labeled d₂, or in substantially the reverse direction of the arrow labeled d₂. Additionally, the system return signal carrying channel C₂ returns to the LIDAR system in the reverse direction of the arrow labeled d₃, or in substantially the reverse direction of the arrow labeled d₃. As a result, different system return signals return to the LIDAR system from different directions. The light from the different system return signals travel through the sequence of components of the LIDAR system in the same sequence disclosed in the context of FIG. 3A and FIG. 3B.

Each of the circulator return signals carries light from a different one of the system return signals. The circulator return signals each enters the second port 142 traveling in a different direction. Accordingly, the light from the circulator return signals can each travel a different pathway through the circulator.

Light in the different the circulator return signals that was in the first polarization state after being reflected by the object (first polarization state source, FPSS) exits from the circulator 104 at a third port 144. For instance, FIG. 3C shows a second FPSS signal (includes the light from the system return signal that carries channel C₃) exiting the circulator from the third port 144. Similarly, the second FPSS signal that includes the light from the system return signal that carries channel C₂ also exits the circulator at the third port 144 as described in the context of FIG. 3A and FIG. 3B.

The different second FPSS signals travel away from the circulator in different directions. As a result, the different first input waveguides 16 on the LIDAR chip are positioned to receive different second FPSS signals. For instance, light from the second FPSS signal that carries channel C₃ is included in the first LIDAR input signal labeled FLIS₃ and light from the second FPSS signal that carries channel C₂ is included in the first LIDAR input signal labeled FLIS₂. The first LIDAR input signal labeled FLIS₃ and the first LIDAR input signal labeled FLIS₂ are received at different first input waveguides 16. As a result, the first input waveguide 16 that receives a first LIDAR input signal can be a function of the direction that the associated system output signal travels away from the LIDAR system and/or of the direction that the associated system return signal travels returns to the LIDAR system. The different second FPSS signals traveling away from the circulator in different directions can be result of the circulator input signals entering the circulator in different directions. As a result, the first input waveguide 16 that receives a first LIDAR input signal can be a function of the direction that the associated circulator input signal enters the circulator and/or of the direction that associated LIDAR output signal travels away from the LIDAR chip. Accordingly, the LIDAR system can be configured such that the circulator input signals enter the circulator traveling in a direction that causes the second FPSS signals to travel away from the circulator in different non-parallel directions.

Light in the circulator return signals that was in the second polarization state after being reflected by the object (first polarization state source, FPSS) exits from the circulator 104 at a fourth port 146. For instance, FIG. 3C shows a third SPSS signal (includes the light from the system return signal that carries channel C₃) exiting the circulator from the fourth port 146. Similarly, the third SPSS signal that includes the light from the system return signal that carries channel C₂ also exits the circulator at the fourth port 146 as described in the context of FIG. 3A and FIG. 3B. After exiting the circulator 104, the third SPSS signal can exit the adapter as shown in FIG. 3C.

The second FPSS signals can serve as circulator output signals. The circulator output signals can include first circulator output signals. Each of the second FPSS signals can serve as one of the first circulator output signals. As a result, each of the first circulator output signals can include, include primarily, consist essentially of, and/or consist of light that was in the first polarization state when it was reflect by an object outside of the LIDAR system (FPSS).

A comparison of FIG. 3A and FIG. 3C shows that light from each of the circulator input signals is operated on by the same selection (a first selection) of circulator components when traveling from the first port 140 to the second port 142. For instance: the light from each of the circulator input signals is operated on by the first polarization beam splitter 106, the second polarization beam splitter 108, the non-reciprocal polarization rotator 110, and the 45° polarization rotator 112 from the component assembly 116; and also by the third polarization beam splitter 114; and also by the 45° polarization rotator 112, the non-reciprocal polarization rotator 110, the second polarization beam splitter 108, and the first polarization beam splitter 106 from the second component assembly 118. However, FIG. 3A and FIG. 3C also shows that the light from each of the each of the circulator input signals can travel a different pathway through the circulator. A comparison of FIG. 3B and FIG. 3C shows that light in each of the first circulator output signals is operated on by the same selection (a second selection) of circulator components when traveling from the second port 142 to the third port 144. However, FIG. 3B and FIG. 3C also shows that the light in each of the first circulator output signals can travel a different pathway through the circulator. A comparison of FIG. 3B and FIG. 3C shows that light in each of the second circulator output signals is operated on by the same selection (a third selection) of circulator components when traveling from the second port 142 to the fourth port 146. However, FIG. 3B and FIG. 3C also shows that the light in each of the second circulator output signals can travel a different pathway through the circulator. As is evident from FIG. 3A through FIG. 3C, the first selection of components, the second selection of components, and the third selection of components can be different.

The outgoing circulator signals can each include, include primarily, consists of, or consists essentially of light from one of the circulator input signals. Additionally, the circulator return signals can each include, include primarily, consists of, or consists essentially of light from one of the circulator input signals, and one of the outgoing circulator signals. Further, the circulator output signals can each include, include primarily, consists of, or consists essentially of light from one of the circulator return signals, one of the outgoing circulator signals, and one of the circulator input signals.

The polarization beam splitters shown in FIG. 3A through FIG. 3C can have the construction of cube-type beamsplitters or Wollaston prisms. As a result, the components described as a beamsplitter can represent a beamsplitting component such as a coating, plate, film, or an interface between light-transmitting materials 150 such as a glass, crystal, birefringent crystal, or prism. A light-transmitting material 150 can include one or more coatings positioned as desired. Examples of suitable coating for a light-transmitting material 150 include, but are not limited to, anti-reflective coatings. In some instances, one, two, three, or four ports selected from the group consisting of the first port 140, the second port 142, the third port 144, and the fourth port 146 are all or a portion of a surface of the circulator. For instance, one, two, three, or four ports selected from the group consisting of the first port 140, the second port 142, the third port 144, and the fourth port 146 can each be all or a portion of a surface of the light-transmitting material 150 as shown in FIG. 3A and FIG. 3B. The surface of the circulator or light-transmitting material 150 that serves as a port can include one or more coatings.

In some instances, the components of the component assembly 116, the second component assembly 118, and/or the circulator 104 are immobilized relative to one another through the use of one or more bonding media such as adhesives, epoxies or solder. In some instances, the components of a component assembly 116 and/or a second component assembly 118 are immobilized relative to one another before being included in the circulator 104. Using a component assembly 116 and a second component assembly 118 with the same construction combined with immobilizing the components of these component assemblies before assembling of the circulator 104 can simplify the fabrication of the circulator.

Although the LIDAR system is disclosed as having a component assembly 116 and a second component assembly 118 with the same construction, the component assembly 116 and second component assembly 118 can have different constructions. For instance, the component assembly 116 can include a 90° polarization rotator 122 that is not used during the operation of the LIDAR system. As a result, the component assembly 116 can exclude the 90° polarization rotator 122. As another example, the component assembly 116 can include, or consist of, the non-reciprocal polarization rotator 110 and the 45° polarization rotator 112. In this example, the non-reciprocal polarization rotator 110 or the 45° polarization rotator 112 can receive the circulator input signals directly from the redirection component 102. As a result, the component assembly 116 can exclude the first polarization beam splitter 106, the second polarization beam splitter 108, the associated light-transmitting material 150, and the 90° polarization rotator 122.

Additionally, the adapter components 99 can be re-arranged and/or are optional. For instance, the beam steering components such as first beam steering component 132 and second beam steering component 132 are optional and beam shaping components such as the second lens 134 can also be optional. As another example, the redirection component 102 is optional. For instance, the LIDAR system can exclude the redirection component 102 and the utility waveguide 13 can be arranged and/or configured such that the different circulator input signals enter the first port 140 traveling in the desired directions.

LIDAR chips include one or more waveguides that constrains the optical path of one or more light signals. While the LIDAR adapter can include waveguides, the optical path that the signals travel between components on the LIDAR adapter and/or between the LIDAR chip and a component on the LIDAR adapter can be free space. For instance, the signals can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, the components on the adapter can be discrete optical components that are attached to the base 102.

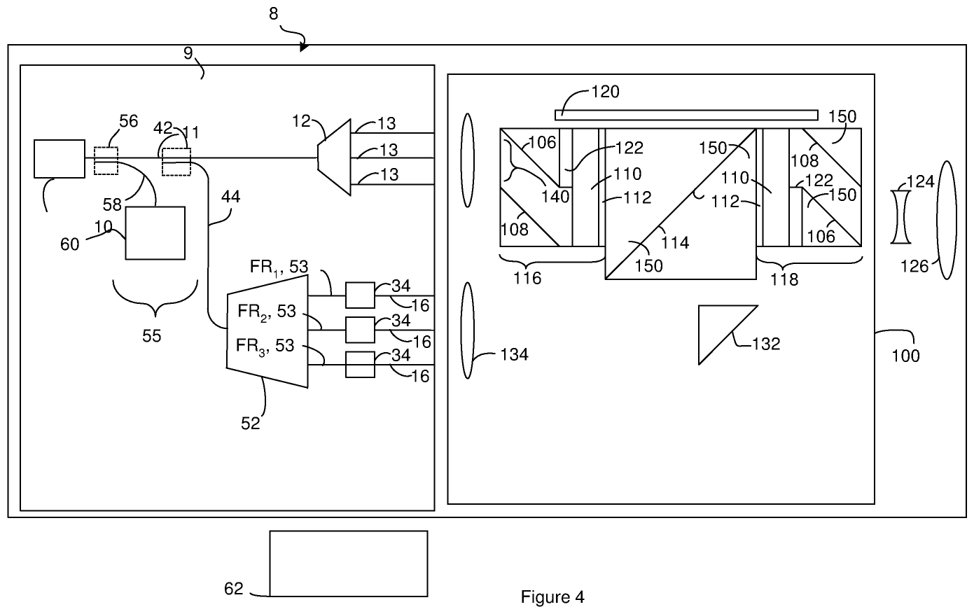

The LIDAR chip, electronics, and the LIDAR adapter can be positioned on a common mount. Suitable common mounts include, but are not limited to, glass plates, metal plates, silicon plates and ceramic plates. As an example, FIG. 4 is a topview of a LIDAR assembly that includes the LIDAR chip and electronics 62 of FIG. 1 and the LIDAR adapter of FIG. 3C on a common support 160. Although the electronics 62 are illustrated as being located on the common support, all or a portion of the electronics can be located off the common support. Suitable approaches for mounting the LIDAR chip, electronics, and/or the LIDAR adapter on the common support include, but are not limited to, epoxy, solder, and mechanical clamping. Although the beam shapers 124, collimator 126, and one or more steering components 128 are shown positioned on the common support 160, one or more components selected from the group consisting of the beam shapers 124, collimator 126, and one or more steering components 128 can be positioned off the common support 160.

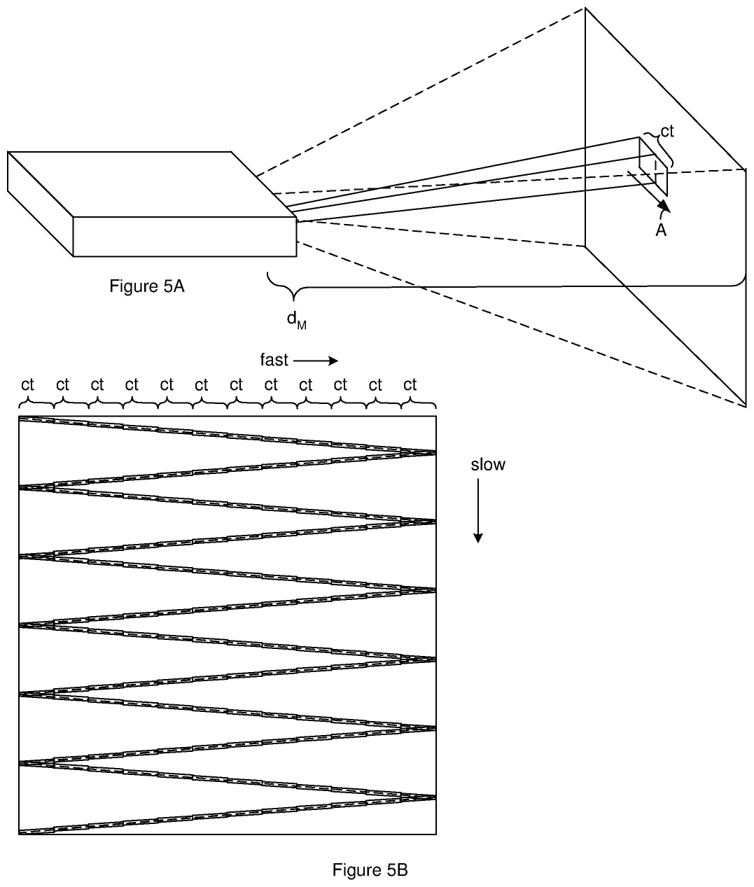

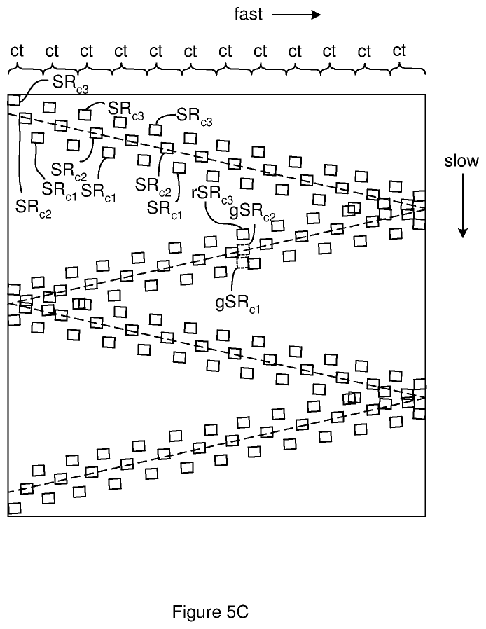

FIG. 5A is a schematic of the relationship between a LIDAR system and the field of view. The field of view is represented by the dashed lines that extend from the LIDAR system to an imaginary surface within the field of view. In order to show the extent of the field of view, the imaginary surface is positioned at a maximum operational distance (labeled d_{M}) from the LIDAR system. The maximum operational distance can generally be considered the maximum distance for which the LIDAR system is configured to provide reliable LIDAR data.

The LIDAR system can include one or more beam steering components (not shown in FIG. 5A through FIG. 5C) that steer the system output signal to different sample regions 129 in the field of view. A portion of a sample region is illustrated by the rectangle on the plane of FIG. 5A. The electronics generate LIDAR data in a series of cycles by sequentially illuminating different sample regions in the field of view for the LIDAR system. LIDAR data can generated for each of the sample regions. A sample region is the portion of the field of view that is illuminated during the cycle that is used to generate the LIDAR data for the sample region. As a result, each of the LIDAR data results is associated with one of the cycles and one of the sample regions.

In FIG. 5A, only a portion of the illustrated sample region is shown as illuminated by the system output signal because the system output signal can continue to be scanned during the data period(s) associated with the sample region. For instance, the system output signal in FIG. 5A can be scanned in the direction of the arrow labeled A for the duration of a cycle. This scan can cause the system output signal to illuminate the length of the plane labeled ct during the cycle. Although the sample region is shown as two dimensional in FIG. 5A, the sample region is three-dimensional and can extend from the rectangle on the illustrated plane back to the LIDAR system.

FIG. 5B is a sideview of the imaginary plane from FIG. 5A. The LIDAR system can include multiple steering mechanisms (not shown in FIG. 5A through FIG. 5C) that steer the system output signal to different sample regions in the field of view. The dashed line in FIG. 5B represents the path that the centroid of the system output signal carrying channel C₂ travels across the plane in the field of view in response to steering of the system output signal by only the one or more beam steering components 128 (a beam steering mechanism) disclosed in the context of FIG. 3A through FIG. 3C. The one or more beam steering components 128 provide two-dimensional steering of the system output signal. The sample regions 129 are represented by the rectangles positioned along path of the system output signal.

The scan path of the system output signal shown in FIG. 5B has a fast axis illustrated by the arrow labeled “fast” in FIG. 5B. The scan path of the system output signal shown in FIG. 5B has a slow axis illustrated by the arrow labeled “slow” in FIG. 5B. The scan speed of the system output signal in the direction of the fast axis is faster than the scan speed of the system output signal in the direction of the slow axis.

In order to have LIDAR data results that represent the entire field of view, it is generally desirable for the number of sample regions in the direction of the fast axis to match the number of sample regions in the direction of the slow axis. The scanning speed in the fast direction can increased so as to increase the number of zigzags that the system output signals travels across the field of view. The increased number of zigzags provides an increased number of sample regions in the direction of the fast axis. However, as the applications for LIDAR systems have increased, the size that is desired for the field of view and the maximum operational distance have increased to dimensions where the scan speed that is required of the one or more beam steering components 128 is not possible or practical and/or has undesirably high power requirements.

FIG. 5C is a sideview of the imaginary plane from FIG. 5A. The dashed line in FIG. 5C represents the path that the centroid of the system output signal when the system output signal channel C₂ is steered by only the one or more beam steering components 128 (the beam steering mechanism) disclosed in the context of FIG. 3A through FIG. 3C. The sample regions of FIG. 5C are vertically separated from one another and from the path provided by the beam steering mechanism as illustrated by the dashed lines. The vertical separation results from the electronics operating the signal directing component 12 so as to change the direction that the system output signal travels away from the LIDAR system. As a result, the operation of the signal steering mechanism moves the system output signal in a direction that is transverse to the path provided by the beam steering mechanism. For instance, the sample regions 129 labeled SR_{c1} can represent the sample region when the signal directing component 12 is operated such that the system output signal carries channel C₁; the sample regions 129 labeled SR_{c2} can represent the sample region when the system output signal carries channel C₂; and the sample regions 129 labeled SR_{c3} can represent the sample region when the system output signal carries channel C₃. As is evident from the sample region sequence shown in FIG. 3C, the signal directing component 12 is operated such that the system output signals sequentially carry the channels Cᵢ in the sequence i=1 through N and the sequence is repeated. Although FIG. 3C illustrates the channel sequence repeated in in the same order, the channel sequence can be repeated in reverse order.

The scanning speed on the fast axis can be slowed relative to the fast axis scanning speed of FIG. 5B while retaining the same frame rate (rate at which each of the sample regions in the field of view is illuminated by the system output signal). For instance, the fast axis scanning speed of FIG. 5C is about 1/N times the fast axis fast axis scanning speed of FIG. 5B where N is the number of utility waveguides 13. The reduced fast axis scanning speed is evident from the reduced number of zigzags within the same frame scan time (1/frame rate). As a result of the reduced fast axis scanning speed, the sample regions have a reduced length in the direction of the fast axis and accordingly have a reduced size. The reduced size of the sample regions leads to increased LIDAR data reliability.

In FIG. 5B, the distance that the system output signal travels along the fast axis during the duration of each cycle is labeled ct. That same distance is also labeled ct in FIG. 5C. Within each distance labeled ct in FIG. 5B and FIG. 5C, there are 12 sample regions spread out across the slow axis. As a result, the combination of using the signal directing component 12 to steer the system output signal and the reduced fast axis scan speed can provide the same slow axis resolution as increasing the fast axis scan speed.

The fast axis scanning speed (speed that the signal steering mechanism provides in the direction of the fast axis) can be represented by the rate of angular change in the direction that the system output signal travels away from the LIDAR system in the direction of the fast axis (the fast axis angular rate of change). The slow axis scanning speed (speed that the signal steering mechanism provides in the direction of the slow axis) can be represented by the rate of angular change in the direction that the system output signal travels away from the LIDAR system in along the slow axis (the slow axis angular rate change). The slow and axis and fast axis can be perpendicular to one another. In some instances, a ratio of the fast axis angular rate of change: the slow axis angular rate of change is greater than 1:1, 2:1, 3:1, or 4:1 and/or less than 5:1, 10:1, or 100:1. Additionally, or alternately, the fast axis angular rate of change can be greater than 100 degrees/second, 200 degrees/second, or 300 degrees/second and/or less than 500 degrees/second, 1000 degrees/second, or and 2000 degrees/second and/or the slow axis angular rate of change can be greater than 20 degrees/second, 50 degrees/second, or 100 degrees/second and/or less than 200 degrees/second, 500 degrees/second, or and 1000 degrees/second.

Although FIG. 5B and FIG. 5C, illustrates the signal steering mechanism steering the system output signal on a zigzag path back and forth across the field of view, the signal steering mechanism can steer the system output signal back and forth across the field of view using other patterns. For instance, the path need not include straight segments connected at sharp angles but can instead include straight segments connected by curves. Alternately, the path can include curves and/or curved segments and can exclude straight segments. For instance, the path can be configured as a series of s-shaped sections.

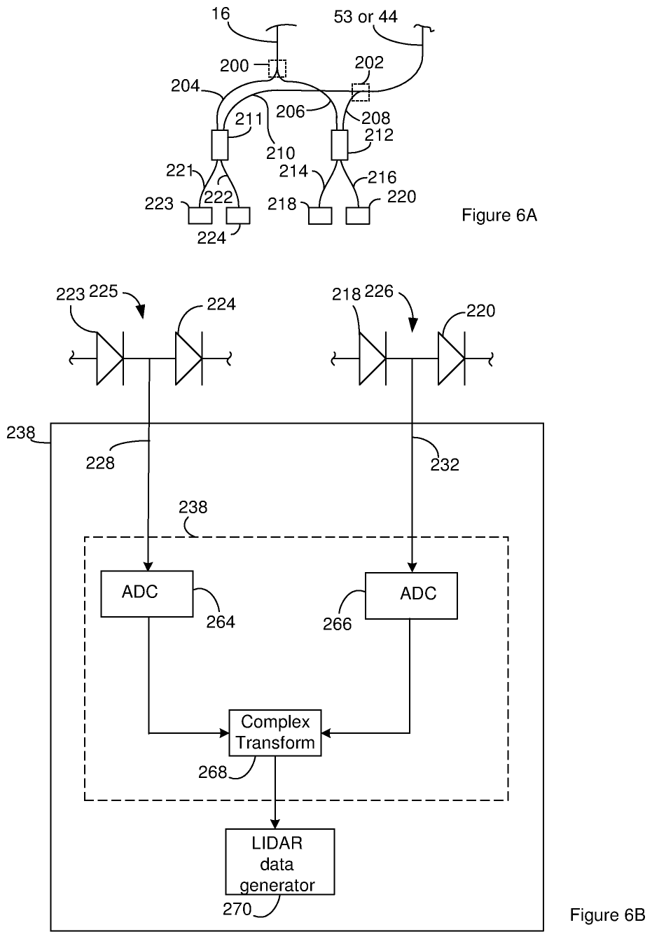

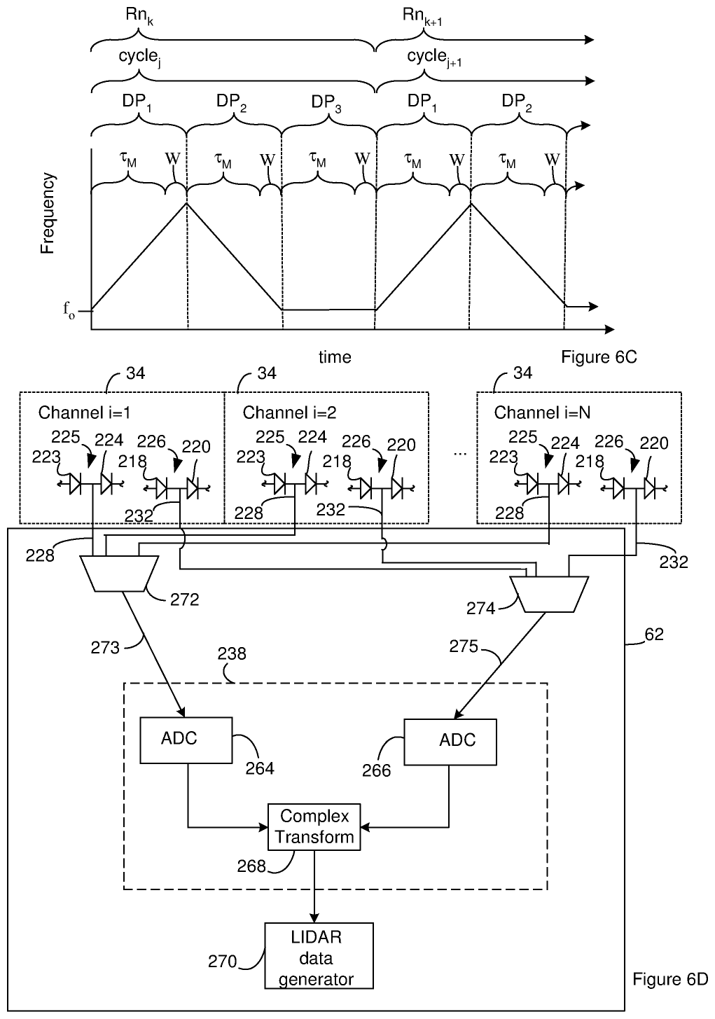

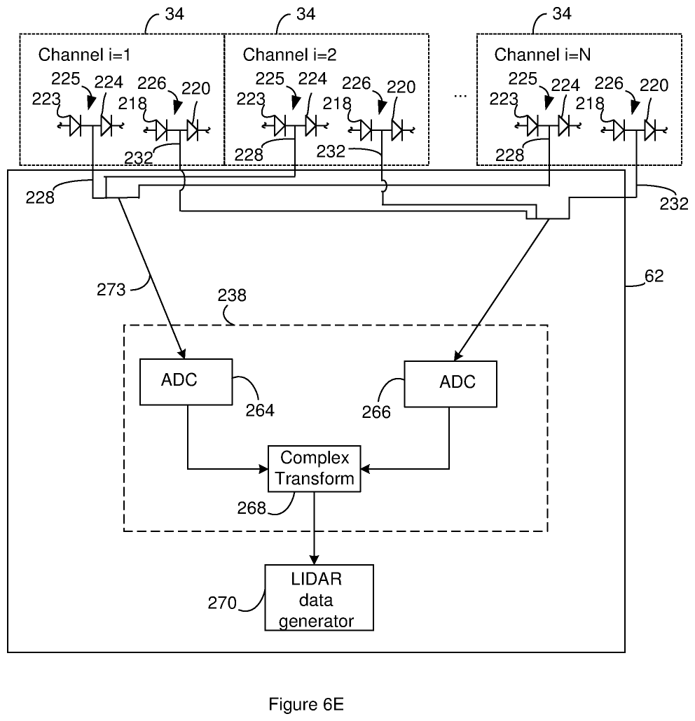

FIG. 6A through FIG. 6B illustrate an example of a processing component that is suitable for use as the first processing component 34 in a LIDAR system constructed according to FIG. 2. In the LIDAR system of FIG. 2, the second signal directing component 64 directs the first LIDAR input signals carried on different first input waveguides 16 to a common waveguide 66. However, first LIDAR input signals that carry different channels are received on different first input waveguides 16. Further, the LIDAR input signals that carry different channels are serially received on the first input waveguides 16 as a result of the signal directing component 12 directing the light source output signal to one of the different utility waveguides 13. As a result, the common waveguide 66 receives the first LIDAR input signals that carry different channels (i.e. that carry light from outgoing LIDAR signals carried on different utility waveguides) in series. Since different channels illuminate different sample regions, the common waveguide 66 receives the first LIDAR input signals that carry light from different sample regions in series. The common waveguide 66 carries the first LIDAR input signals to the first processing component 34 where they serve as comparative signals. As a result, the first processing component 34 receives comparative signals that carry light from different sample regions in series. As noted above, the first processing component 34 also receives a reference signal from the intermediate waveguide 44.

The first processing component 34 includes an optical-to-electrical assembly configured to convert the light signals to electrical signals. FIG. 6A is a schematic of an example of a suitable optical-to-electrical assembly that includes a first splitter 200 that divides the comparative signal received from the common waveguide 66 onto a first comparative waveguide 204 and a second comparative waveguide 206. The first comparative waveguide 204 carries a first portion of the comparative signal to a light-combining component 211. The second comparative waveguide 206 carries a second portion of the comparative signal to a second light-combining component 212.

The processing component of FIG. 6A also includes a second splitter 202 that divides the reference signal received from the intermediate waveguide 44 onto a first reference waveguide 210 and a second reference waveguide 208. The first reference waveguide 210 carries a first portion of the reference signal to the light-combining component 211. The second reference waveguide 208 carries a second portion of the reference signal to the second light-combining component 212.

The second light-combining component 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light-combining component 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light-combining component 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light-combining component 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light-combining component 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light-combining component 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light-combining component 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light-combining component 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light-combining component 212 splits the second composite signal such that the portion of the comparative signal in the first portion of the second composite signal is phase shifted by 180° relative to the portion of the comparative signal in the second portion of the second composite signal, the light-combining component 211 also splits the composite signal such that the portion of the comparative signal in the first portion of the composite signal is phase shifted by 180° relative to the portion of the comparative signal in the second portion of the composite signal. When the second light-combining component 212 splits the second composite signal such that the portion of the reference signal in the first portion of the second composite signal is phase shifted by 180° relative to the portion of the reference signal in the second portion of the second composite signal, the light-combining component 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90 degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. For instance, FIG. 6B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 6B are included on the LIDAR chip. In some instances, the components illustrated in the schematic of FIG. 6B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 62 includes a transform mechanism 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transform mechanism 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transform mechanism 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transform mechanism 238 includes a transform component 268 that receives the complex data signal. For instance, the transform component 268 receives the first digital data signal from the first Analog-to-Digital Converter (ADC) 264 as an input and also receives the second digital data signal from the first Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The electronics include a LIDAR data generator 270 that receives the output from the transform component 268 and processes the output from the transform component 268 so as to generate the LIDAR data (distance and/or radial velocity between the reflecting object and the LIDAR chip or LIDAR system). The LIDAR data generator performs a peak find on the output of the transform component 268 to identify one or more peaks in the beat frequency.

The electronics use the one or more frequency peaks for further processing to generate the LIDAR data (distance and/or radial velocity between the reflecting object and the LIDAR chip or LIDAR system). The transform component 268 can execute the attributed functions using firmware, hardware or software or a combination thereof.

FIG. 6C shows an example of a relationship between the frequency of the system output signal, time, cycles and data periods. The base frequency of the system output signal (fₒ) can be the frequency of the system output signal at the start of a cycle.

FIG. 6C shows frequency versus time for a sequence of two cycles labeled cycleⱼ and cycleⱼ₊₁. In some instances, the frequency versus time pattern is repeated in each cycle as shown in FIG. 6C. The illustrated cycles do not include re-location periods and/or re-location periods are not located between cycles. As a result, FIG. 6C illustrates the results for a continuous scan where the steering of the system output signal is continuous.

Each cycle includes K data periods that are each associated with a period index k and are labeled DPₖ. In the example of FIG. 6C, each cycle includes three data periods labeled DPₖ with k=1, 2, and 3. In some instances, the frequency versus time pattern is the same for the data periods that correspond to each other in different cycles as is shown in FIG. 6C. Corresponding data periods are data periods with the same period index. As a result, each data period DP₁ can be considered corresponding data periods and the associated frequency versus time patterns are the same in FIG. 6C. At the end of a cycle, the electronics return the frequency to the same frequency level at which it started the previous cycle.

During the data period DP₁, and the data period DP₂, the electronics operate the light source such that the frequency of the system output signal changes at a linear rate α. The direction of the frequency change during the data period DP₁ is the opposite of the direction of the frequency change during the data period DP₂.

FIG. 6C labels sample regions that are each associated with a sample region index k and are labeled Rnₖ. FIG. 6C labels sample regions Rnₖ and Rnₖ₊₁. Each sample region is illuminated with the system output signal during the data periods that FIG. 6C shows as associated with the sample region. For instance, sample region Rnₖ is illuminated with the system output signal during the data periods labeled DP₁ through DP₃. The sample region indices k can be assigned relative to time. For instance, the sample regions can be illuminated by the system output signal in the sequence indicated by the index k. As a result, the sample region Rn₁₀ can be illuminated after sample region Rn₉ and before Rn₁₁.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled τM in FIG. 6C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a LIDAR beat frequency, the electronics measure the LIDAR beat frequency that results from system return signal that return to the LIDAR system during a data window in the data period. The data window is labeled “W” in FIG. 6C. The contribution from the LIDAR signal to the composite signals will be present at times larger than the maximum operational time delay (τM). As a result, the data window is shown extending from the maximum operational time delay (τM) to the end of the data period.

A frequency peak in the output from the Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 6C can be combined with the beat frequency determined from DP₂ in FIG. 6C to determine the LIDAR data. As an example, the following equation applies during a data period where electronics increase the frequency of the outgoing LIDAR signal during the data period such as occurs in data period DP₁ of FIG. 6C: f_{ub}=−f_{d}+ατ where f_{ub} is the frequency provided by the transform component (f_{LDP} determined from DP₁ in this case), f_{d} represents the Doppler shift (f_{d}=2vf_{c}/c) where G represents the optical frequency (fₒ), c represents the speed of light, v is the radial velocity between the reflecting object and the LIDAR system where the direction from the reflecting object toward the chip is assumed to be the positive direction, τ is the time in which the light from the system output signal travels to the object and returns to the LIDAR system (the roundtrip time), and c is the speed of light. The following equation applies during a data period where electronics decrease the frequency of the outgoing LIDAR signal such as occurs in data period DP₂ of FIG. 6C: f_{db}=−f_{d}−ατ where f_{db} is a frequency provided by the transform component (f_{i, LDP} determined from DP₂ in this case). In these two equations, f_{d} and τ are unknowns. The electronics solve these two equations for the two unknowns. The radial velocity for the sample region then be determined from the Doppler shift (v=c*f_{d}/(2f_{c})) and/or the separation distance for that sample region can be determined from c*τ/2. Since the LIDAR data can be generated for each corresponding frequency pair output by the transform, separate LIDAR data can be generated for each of the objects in a sample region. Accordingly, the electronics can determine more than one radial velocity and/or more than one radial separation distance from a single sampling of a single sample region in the field of view.

The data period labeled DP₃ in FIG. 6C is optional. As noted above, there are situations where more than one object is present in a sample region. For instance, during the feedback period in DP₁ for cycle₂ and also during the feedback period in DP₂ for cycle₂, more than one frequency pair can be matched. In these circumstances, it may not be clear which frequency peaks from DP₂ correspond to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 6C. When there are two objects in a sample region illuminated by the LIDAR outputs signal, the transform component outputs two different frequencies for f_{ub}: fᵤ₁ and fᵤ₂ during DP₁ and another two different frequencies for f_{db}: f_{d1} and f_{d2} during DP₂. In this instance, the possible frequency pairings are: (f_{d1}, fᵤ₁); (f_{d1}, fᵤ₂); (f_{d2}, fᵤ₁); and (f_{d2}, f_{du2}). A value of f_{d} and τ can be calculated for each of the possible frequency pairings. Each pair of values for f_{d} and τ can be substituted into f₃=−f_{d}+α₃τ₀ to generate a theoretical f₃ for each of the possible frequency pairings. The value of α₃ is different from the value of α used in DP₁ and DP₂. In FIG. 6C, the value of α₃ is zero. In this case, the transform component also outputs two values for f₃ that are each associated with one of the objects in the sample region. The frequency pair with a theoretical f₃ value closest to each of the actual f₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region

Each of the first processing components 34 illustrated in FIG. 1 can be operated as disclosed in the context of FIG. 6A through FIG. 6C. For instance, the first reference signal received by each of the processing components 34 can serve as the reference signal described in the context of FIG. 6A through FIG. 6C and the first comparative signal received by each of the processing components 34 can serve as the comparative signal described in the context of FIG. 6A through FIG. 6C. As discussed above, first the LIDAR input signals that carry different channels are serially received on the first input waveguides 16 and the first LIDAR input signals that carry different channels are received on different first input waveguides 16. As a result, the first processing component 34 configured to receive the first comparative signal carrying channel i receives the first comparative signal in response to the signal directing component 12 being operated such that the LIDAR output signal carrying channel i is output from the utility waveguides. Additionally, first processing component(s) 34 that are not configured to receive the first comparative signal carrying channel i do not substantially receive a first comparative signal in response to the signal directing component 12 being operated such that the LIDAR output signal carrying channel i is output from the utility waveguides. As a result, only a portion of the first processing component(s) 34 receives the first comparative signals and the first processing component(s) 34 that receives the first comparative signal changes in response to operation of the signal directing component 12. The electronics can coordinate the first processing component(s) 34 that is used to generate the LIDAR data with the operation of the signal directing component 12. For instance, the electronics can select the first processing component 34 that is currently receiving the first comparative signal to generate the LIDAR data. As an example, for a cycle where the electronics operate the signal directing component 12 such that the LIDAR output signal carrying channel i is output from the utility waveguides, the first processing component 34 that is configured to receive the first comparative signal carrying channel i is selected for the generation of LIDAR data while LIDAR data is not generated from the unselected first processing component(s) 34.

In the LIDAR system of FIG. 1, the electronics from different first processing components 34 can be combined so that beating signals are combined electronically rather than optically. For instance, each of the first processing components 34 can include the optical-to-electrical assembly of FIG. 6A. FIG. 6D is a schematic of the relationship between the first light sensor 223, the second light sensor 224, the first auxiliary light sensor 218, and the second auxiliary light sensor 220 in each of the optical-to-electrical assemblies from FIG. 6A and the electronics. Since each of the different first processing components 34 receive a first LIDAR input signal carrying a different channel, FIG. 6D illustrates the first light sensor 223, the second light sensor 224, the first auxiliary light sensor 218, and the second auxiliary light sensor 220 associated with the channel received by the light sensor.

The first data lines 228 from each of the different first balanced detectors 225 carries the first data signal to a first electrical multiplexer 272. The first electrical multiplexer 272 outputs the first data signals from different first data lines 228 on a common data line 273. Since system output signals that carry different channels are serially output from the LIDAR system, the first LIDAR input signals that carry different channels are serially received on the first input waveguides 16 and the first LIDAR input signals that carry different channels are received on different first input waveguides 16. As a result, the first processing component 34 configured to receive the first comparative signal carrying channel i receives the first comparative signal in response to the signal directing component 12 being operated such that the system output signal carrying channel i is output from the LIDAR system. Additionally, first processing component(s) 34 that are not configured to receive the first comparative signal carrying channel i do not substantially receive a first comparative signal in response to the signal directing component 12 being operated such that the system output signal carrying channel i is output from the LIDAR system. Since the system output signals that carry different channels are serially output from the LIDAR system, the first comparative signals carrying different channels are serially received at different first processing component(s) 34 although there may be some overlap of different channels that occurs. Since the first processing component(s) 34 serially receive the first comparative signals carrying different channels, the first common data line 273 carries first data signals that carry different channels in series. There may be some short term overlap between channels in the series of first data signals, however, the overlap does not occur in the data windows illustrated in FIG. 6C. The first common data line 273 carries the series of first data signals to the first Analog-to-Digital Converter (ADC) 264.

The second data lines 232 from each of the different second balanced detectors 226 carries the second data signal to a second electrical multiplexer 274. The second electrical multiplexer 274 outputs the second data signals from different second data line 232 on a second common data line 275. As noted above, the first processing component(s) 34 serially receive the first comparative signals carrying different channels. As a result, the second common data line 275 carries second data signals that carry different channels in series. There may be some short term overlap between channels in the series of second data signals, however, the overlap does not occur during the data windows illustrated in FIG. 6C. The second common data line 275 carries the series of second data signals to the second Analog-to-Digital Converter (ADC) 266.

The transform mechanism 238 and LIDAR data generator 270 of FIG. 6D can be operated as disclosed in the context of FIG. 6A through FIG. 6C. For instance, the first Analog-to-Digital Converter (ADC) 264 converts the first data signal from an analog form to a digital form and outputs the first digital data signal. The second Analog-to-Digital Converter (ADC) 266 converts the second data signal from an analog form to a digital form and outputs a second digital data signal.

A first digital data signal and the second digital data signal carrying the same channel act together as a complex signal where the first digital data signal acts as the real component of the complex signal and the second digital data signal acts as the imaginary component of the complex data signal. The electronics are configured such that the first digital data signals and the second digital data signals carrying the same channel are concurrently received by the LIDAR data generator 270. As a result, the LIDAR data generator 270 receives a complex signals that carries different channels in series. The LIDAR data generator 270 can generate LIDAR data for each of the different channels. As a result, the data generator 270 can generate LIDAR data for each sample region that is illuminated by the system output signals carrying the series of channels.

In another embodiment of a LIDAR system where the relationship between sensors in the optical-to-electrical assembly from FIG. 6A and electronics in the LIDAR system is constructed according to FIG. 6D, the electronics operate the electrical multiplexers as a switch that can be operated by the electronics. As a result, the electronics can operate the first electrical multiplexer 272 so as select which of the first data signals are output on the common data line 273 and can operate the second electrical multiplexer 274 so as select which of the second data signals are output on the second common data line 275. As a result, the LIDAR system can be configured to concurrently output the system output signals that carry different channels. For instance, the LIDAR chip can be configured to concurrently output each of the LIDAR output signals carrying the different channels.

When the LIDAR system concurrently outputs system output signals that carry different channels, each of the different first processing components 34 can concurrently receive a first LIDAR input signal carrying one of the channels. Accordingly, the first data lines 228 from each of the different first processing components 34 concurrently carries the first data signal to the first electrical multiplexer 272. As a result, the first electrical multiplexer 272 concurrently receives multiple first data signals that each carries a different channels and is from a different first processing component 34. The electronics use the switching functionality of the first electrical multiplexer 272 to operate the first electrical multiplexer 272 such that the first electrical multiplexer 272 outputs the first data signals carrying different channels in series. As a result, the first common data line 273 carries first data signals that carry different channels in series. An example of a suitable channel series, includes, but is not limited to, the sequence of channels having channel index i=1 through N from i=1 in the numerical sequence from i=1 through to i=N.

The second data lines 232 from each of the different first processing components 34 concurrently carries a second data signal to the second electrical multiplexer 274. As a result, the second electrical multiplexer 274 concurrently receives multiple second data signals that each carries a different channels and is from a different first processing component 34. The electronics use the switching functionality of the second electrical multiplexer 274 to operate the second electrical multiplexer 274 such that the second electrical multiplexer 274 outputs the second data signals carrying different channels in series. As a result, the second data line 275 carries second data signals that carry different channels in series.

The transform mechanism 238 and LIDAR data generator 270 of FIG. 6D can be operated as disclosed in the context of FIG. 6A through FIG. 6C. For instance, the first Analog-to-Digital Converter (ADC) 264 converts the first data signal from an analog form to a digital form and outputs the first digital data signal. The second Analog-to-Digital Converter (ADC) 266 converts the second data signal from an analog form to a digital form and outputs a second digital data signal.

The first electrical multiplexer 272 and the second electrical multiplexer 274 are operated such that the first data line 273 and the second data line 275 concurrently carry the same channel. As a result, the first digital data signal and the second digital data signal output from the first Analog-to-Digital Converter (ADC) 264 and the second Analog-to-Digital Converter (ADC) 266 concurrently carry the same channel. The first digital data signal and the second digital data signal carrying the same channel act together as a complex signal where the first digital data signal acts as the real component of the complex signal and the second digital data signal acts as the imaginary component of the complex data signal. The first digital data signals and the second digital data signals carrying the same channel are concurrently received by the LIDAR data generator 270. As a result, the LIDAR data generator 270 receives a complex signals that carries different channels in series. The LIDAR data generator 270 can generate LIDAR data for each of the channel in the series of channels. As a result, the data generator 270 can generate LIDAR data for each sample region that is illuminated by the system output signals carrying the series of channels.

When the LIDAR system concurrently outputs system output signals that carry different channels as described above, the system output signals travel away from the LIDAR system in different directions. As a result, the field of view will have multiple different sample regions that are concurrently illuminated by a different one of the different system output signals. As an example, FIG. 5C has sample regions illustrated with dashed lines and labeled gSR_{c1} and gSR_{c2}. The sample regions labeled gSR_{c1} and gSR_{c2} are illuminated concurrently with the sample regions labeled rSR_{c3}. However, the operation of the first electrical multiplexer 272 and the second electrical multiplexer 274 selects which channel is received by the LIDAR data generator 270. When the LIDAR data generator 270 receives the signals generated from illumination of the sample region labeled rSR_{c3}, the LIDAR data generator 270 does not receive signals generated from illumination of the sample regions labeled gSR_{c1} and gSR_{c2}. As a result, the LIDAR data generator 270 generates LIDAR data results for the sample region labeled rSR_{c3} but does not generate LIDAR data results for the sample regions labeled gSR_{c1} and gSR_{c2} and these sample regions effectively become ghost sample regions. As a result, the one or more electrical multiplexers included in the LIDAR system selects the sample region for which the LIDAR data results will be generated rather than the output from the signal directing component 12 selecting the sample region for which the LIDAR data results will be generated.

An alternative to the first electrical multiplexer 272 and/or the second electrical multiplexer 274 is to provide an electrical node where the first data lines 228 from each of the different first balanced detectors 225 are in electrical communication with one another and a second electrical node the second data lines 232 from each of the different second balanced detectors 226 are in electrical communication with one another. As a result, the outputs of the first balanced detectors 225 are effectively connected in parallel and the outputs of the second balanced detectors 226 are effectively connected in parallel. As an example, FIG. 6E illustrates the arrangement of FIG. 6D modified such that the first data lines 228 from each of the different first balanced detectors 225 are in electrical communication with the first common data line 273. Since the LIDAR system outputs system output signals that carry different channels in series, the first common data line 273 carries first data signals that carry different channels in series. While there may be some overlap between channels that are adjacent to one another in the series, the overlap does not occur during the data window. Additionally, the second data lines 232 from each of the different second balanced detectors 226 are in electrical communication with the second common data line 275. Since the LIDAR system outputs system output signals that carry different channels in series, the second common data line 275 carries second data signals that carry different channels in series. While there may be some overlap between channels that are adjacent to one another in the series, the overlap does not occur during the data window. Since the first common data line 273 carries first data signals that carry different channels in series and the second common data line 275 carries second data signals that carry different channels in series as also occurs in the LIDAR system of FIG. 6D, the transform mechanism 238 and LIDAR data generator 270 can be operated as disclosed in the context of FIG. 6E to generate LIDAR data for each sample region that is illuminated by the system output signals carrying the series of channels.

In a LIDAR system constructed according to FIG. 6E, during a cycle when the LIDAR system is outputting a system output signal that carries channel i, the processing component 34 configured to receive the current channel i (the active processing component) receives the first LIDAR input signals that carries channel i during at least the data window while the processing component 34 that are not configured to receive the current channel i (the inactive processing component(s)) do not receive a first LIDAR input signal. However, the inactive processing component(s) continue to receive a first reference signal during at least the data window. Light from the first reference signal(s) received by the inactive processing component(s) can pass through the optical-to-electrical assemblies and become noise in electrical signals such as the first data signals and the second data signals.

In some instances, it may be desirable to fully or partially attenuate all or a portion of the first reference signal(s) received by the inactive processing component(s). For instance, the first reference waveguide 53 (FIG. 1) can each optionally include an optical attenuator 280. The attenuators 280 can be operated by the electronics so as to fully or partially attenuate the first reference signal guided by the first reference waveguide 53 along which the attenuator is positioned.

The processing component 34 that serves as the active processing component and the processing component(s) 34 that serve as the active processing component(s) changes as the channel carried by the system output signal changes. As a result, the electronics can change the first reference signal(s) that are attenuated in response to changes in the channel that is currently being carried in the system output signal. For instance, the electronics can operate the attenuators 280 such that the first reference signal to be received by an active processing component is not attenuated or is not substantially attenuated. Additionally, the electronics can operate the attenuators 280 such that the first reference signal(s) to be received by all or a portion of the inactive processing component(s) is fully or partially attenuated. Since the first reference signal(s) to be received by all or a portion of the inactive processing component(s) is fully or partially attenuated, the amount of light from the first reference signals that is actually received by the inactive processing component(s) is reduced. As a result, the attenuated light is not a source of noise in the first data signal and the second data signal.

Suitable devices suitable for use as an optical attenuator 280 include, but are not limited to, variable optical attenuators (VOAs), PIN diodes, and Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

In addition or as an alternative to the optical attenuators 280, the reference splitter 52 (FIG. 1) can be replaced with an optical switch. The optical switch is configured to direct the preliminary reference signal to one of the first reference waveguides 53. The portion of the preliminary reference signal received by a first reference waveguide 53 serves as a first reference signal. The optical switch can be operated by the electronics such that the electronics can select which of the first reference waveguides 53 receives the preliminary reference signal. As a result, the electronics can select which one of the first reference waveguides 53 carries the first reference signal. Since the first reference waveguides 53 that receives the first reference signal guides the first reference signal to one of the processing components 34, the electronics select which one of the processing components receives the first reference signal.

The electronics can change the first reference waveguide 53 that receives the preliminary reference signal in response to changes in the channel that is currently being carried in the system output signal. For instance, the electronics can operate the optical such that the first reference signal is received by the active processing component during at least the data window. Since only one of the processing components receives the first reference signal, the inactive processing component(s) do not receive a first reference signal.

The processing component 34 that serves as the active processing component and the processing component(s) 34 that serve as the active processing component(s) changes as the channel carried by the system output signal changes. As a result, the electronics can operate the optical switch so as to change the processing component 34 that receives the first reference signal such that the processing component that is currently serving as the active processing component for each cycle receives the first reference signal for at least all or a portion of the data window(s) in that cycle. As a result, in each cycle, the inactive processing component(s) do not receive a first reference signal. Since the inactive processing component(s) do not receive or do not substantially receive light from the first reference signal, light from a first reference signal that is received by an inactive processing component does not pass through an optical-to-electrical assembly and is not a source of noise in the first data signal and the second data signal.

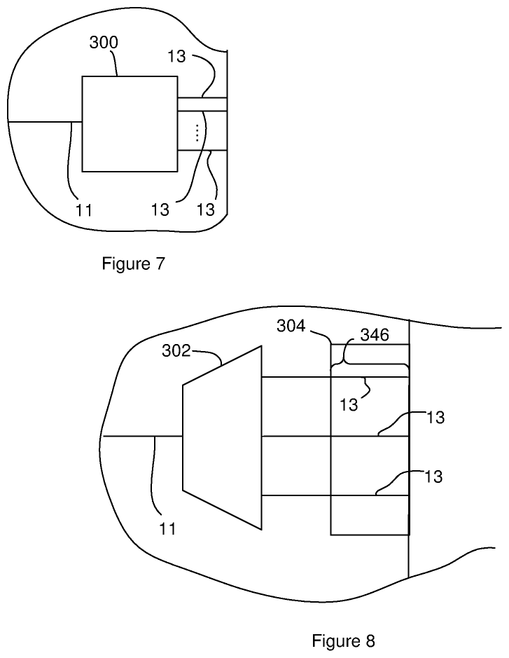

FIG. 7 is a topview of a signal directing component 12 that is suitable for use with the LIDAR system. The signal directing component 12 includes an optical switch 300 that receives the light source output signal from the source waveguide 11. The portion of the light source output signal received at the optical switch 300 can serve as a switch signal. The optical switch 300 directs the switch signal to one of the utility waveguides 13. The optical switch 300 can be operated by the electronics 62. For instance, the electronics can operate the optical switch 300 so as to control which of the utility waveguides 13 receives the switch signal. The portion of the switch signal received by the utility waveguide can serve as the outgoing LIDAR signals. Suitable optical switches include, but are not limited to, Semiconductor Optical Amplifers (SOAs), and cascaded 2×2 Mach-Zehnder interferometer switches using thermal or free-carrier injection phase shifters.

FIG. 8 is a topview of another signal directing component 12 that is suitable for use with the LIDAR system. The signal directing component 12 includes a splitter 302 that receives the light source output signal from the source waveguide 11. The splitter 302 is configured to divide the light source output signal into utility signals that are each received at a different one of the utility waveguides 13. The splitter 302 can be configured such that each of the utility waveguides 13 concurrently receives one of the utility signals. The portion of a utility signal carried on one of the utility waveguides 13 can serve as the as the outgoing LIDAR signal output from that utility waveguide 13. The splitter 302 can be a wavelength independent splitter such as an optical coupler, y-junction, MMI, cascaded evanescent optical couplers, or cascaded y-junctions. As a result, the LIDAR output signals can each have the same, or about the same, distribution of wavelengths. For instance, the splitter 302 can be configured such that each of the utility signals carries the same or substantially the same selection of wavelengths.

An amplifier 304 is positioned along each of the utility waveguides 13. The amplifier 304 can be operated by the electronics so as to amplify the outgoing LIDAR signal on one of the utility waveguides 13. The electronics can select the utility waveguide 13 on which the outgoing LIDAR signal is amplified. The amplifier can be configured such that each outgoing LIDAR signal carried on an unamplified utility waveguide 13 is fully or partially absorbed by the amplifier. For instance, the amplifier can guide the outgoing LIDAR signals through a gain medium which absorbs light at the wavelength of the outgoing LIDAR signals. As a result, the LIDAR output signals output from the unamplified utility waveguide(s) 13 are at lower power levels than the power level of the outgoing LIDAR signal that was received by the unamplified utility waveguide(s) 13. For instance, the unamplified utility waveguide(s) 13 can have a length where the LIDAR output signals output from the unamplified utility waveguide(s) 13 have a power level less than 0.01%, 0.1%, or 1% of the power level of the outgoing LIDAR signal that was received by the unamplified utility waveguide(s) 13. In contrast, the LIDAR output signal output from the amplified utility waveguide(s) 13 are at higher power levels than the power level of the outgoing LIDAR signal that was received by the amplified utility waveguide 13. For instance, the LIDAR output signal output from the amplified utility waveguide 13 can have a power level more than 200%, 500%, or 1000% of the power level of the outgoing LIDAR signal that was received by the amplified utility waveguide 13. As a result of this power differential, the LIDAR output signal output from the amplified utility waveguide 13 serves as the LIDAR outputs signal output from the LIDAR chip. Accordingly, the amplifier acts as an optical switch that selects which of the outgoing LIDAR signals will be output as the LIDAR outputs signal output from the LIDAR chip.

As noted above, the electronics operate the signal directing component 12 so as to select which utility waveguide 13 outputs the LIDAR outputs signal. Accordingly, in a cycle where the amplifier 304 is to output the LIDAR output signal carrying channel i, the electronics amplify the utility waveguide associated with the current channel i but do not amplify or do not substantially amplify utility waveguide(s) that are not associated with the current channel i. When a new cycle occurs where the amplifier 304 is to output a LIDAR output signal carrying a different channel, the electronics amplify the utility waveguide associated with the new channel but do not amplify or do not substantially amplify utility waveguide(s) that are not associated with the current channel i. As a result, the electronics operate the signal directing component 12 so the LIDAR outputs signal carries the desired channel.

In some instances, it may be desirable for the LIDAR chip to include one or more amplifiers. For instance, one or more amplifiers can be positioned at one or more locations along the source waveguide 11 to amplify the light source output signal and accordingly the system output signal as well as other signal that includes or consists of light from the light source output signal. The LIDAR system of FIG. 1 and FIG. 2 illustrates an optional amplifier 310 positioned along the source waveguide 11. The amplifier 310 can compensate for power loss that occurs as a result of using the splitter 302 in the signal directing component 12 as shown in FIG. 8. When the signal directing component 12 includes an optical switch 300 as shown in FIG. 7, the loss associated with splitter 302 is reduced and the need for the amplifier 310 can be reduced and/or eliminated.

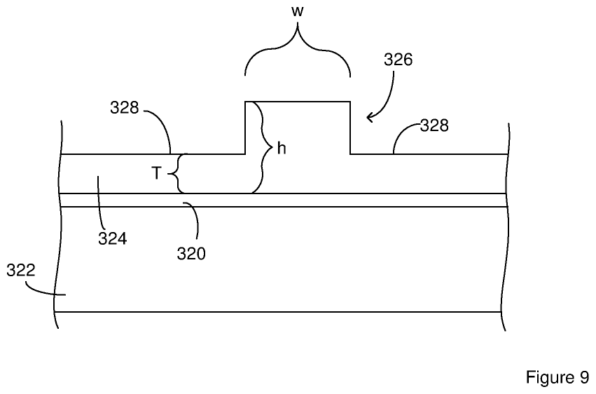

Suitable platforms for the LIDAR chips include, but are not limited to, silica, indium phosphide, and silicon-on-insulator wafers. In some instances, the wafer has a light-transmitting medium on a base. As an example, FIG. 9 is a cross-section of portion of a LIDAR chip constructed from a silicon-on-insulator wafer. A silicon-on-insulator (SOI) wafer includes a buried layer 320 included in a base 321 that has the buried layer on a substrate 322. Additionally, the wafer includes a light-transmitting medium 324 positioned on the base 321 with the buried layer 320 between the substrate 322 and the light-transmitting medium 324. In a silicon-on-insulator wafer, the buried layer is silica while the substrate and the light-transmitting medium are silicon. The substrate of an optical platform such as an SOI wafer can serve as the base for the entire chip. For instance, the optical components shown in FIG. 1 can be positioned on or over the top and/or lateral sides of the substrate.

The portion of the chip illustrated in FIG. 9 includes a waveguide construction that is suitable for use with chips constructed from silicon-on-insulator wafers. A ridge 326 of the light-transmitting medium extends away from slab regions 328 of the light-transmitting medium. The light signals are constrained between the top of the ridge and the buried oxide layer.

The dimensions of the ridge waveguide are labeled in FIG. 9. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 9 is suitable for all or a portion of the waveguides on LIDAR chips constructed according to FIG. 1 through FIG. 4.

When the LIDAR chip includes one or more amplifiers, one or more amplifiers can be integrated onto the platform of the LIDAR chip. For instance, one or more amplifiers can be integrated onto LIDAR chip constructed on a silicon-on-insulator wafer. An example of an amplifier construction that can be integrated onto a silicon-on-insulator wafer can be found in U.S. patent application Ser. No. 13/317,340, filed on Oct. 14 2011, entitled Gain Medium Providing Laser and Amplifier Functionality to Optical Devices, and incorporated herein in its entirety.

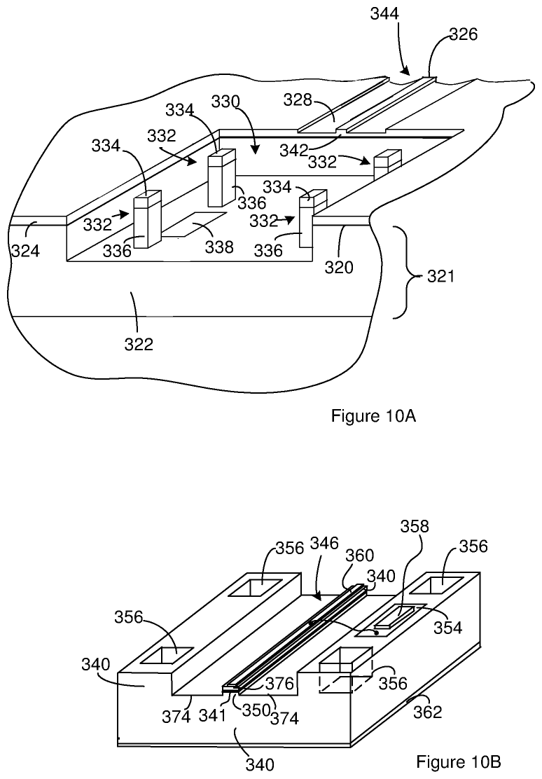

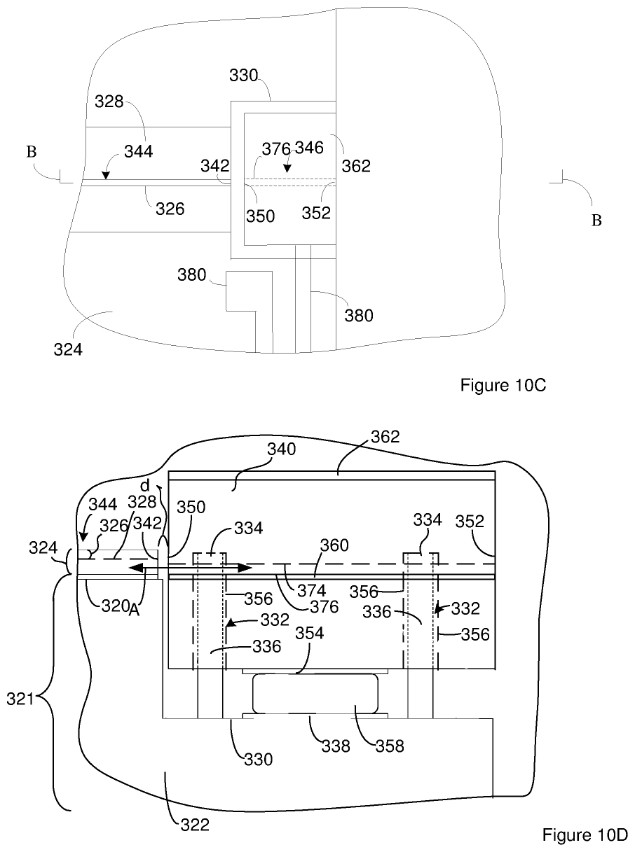

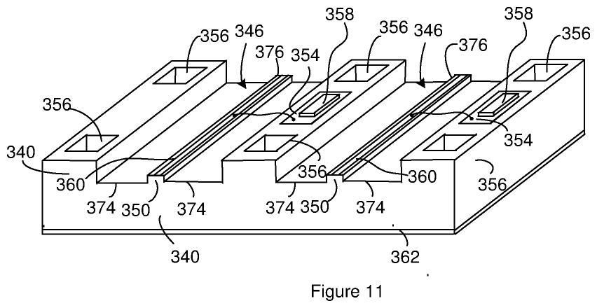

FIG. 10A is a perspective view of a portion of a LIDAR chip that includes an interface for optically coupling the LIDAR chip with an amplifier chip. The illustrated portion of the LIDAR chip includes a stop recess 330 sized to receive the amplifier. The stop recess 330 extends through the light-transmitting medium 324 and into the base 321. In the illustrated version, the stop recess 330 extends through the light-transmitting medium 324, the buried layer 320, and into the substrate 322.

A facet 342 of the light-transmitting medium 324 serves as a lateral side of the stop recess 30. The facet 342 can be a facet of a waveguide 344 depending on the application of the amplifier. For instance, the facet 342 can be a facet of a source waveguide when the amplifier is used as disclosed in the context of FIG. 1 or a facet of a utility waveguide when the amplifier is used as disclosed in the context of FIG. 8. Although not shown, the facet 342 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

One or more stops 332 extend upward from a bottom of the stop recess 330. For instance, FIG. 10A illustrates four stops 332 extending upward from the bottom of the stop recess 330. The stops 332 include a cladding 334 positioned on a base portion 336. The substrate 322 can serve as the base portion 336 of the stops 332 and the stop 332 can exclude the buried layer 320. The portion of the substrate 322 included in the stops 332 can extend from the bottom of the stop recess 330 up to the level of the buried layer 320. For instance, the stops 332 can be formed by etching through the buried layer 320 and using the underlying substrate 322 as an etch-stop. As a result, the location of the top of the base portion 336 relative to the optical mode of a light signal in the waveguide 384 is well known because the buried layer 320 defines the bottom of the second waveguide and the top of the base portion 336 is located immediately below the buried layer 320. The cladding 334 can be formed on base portion 336 of the stops 332 so as to provide the stops 332 with a height that will provide the desired alignment between the waveguide 384 and an amplifier waveguide on an amplifier chip.

Attachment pads 338 are positioned on the bottom of the stop recess 330. The attachment pads 338 can be used to immobilize the amplifier chip relative to the LIDAR chip once the amplifier chip is positioned on the LIDAR chip. In some instances, the attachment pads 338 also provide electrical communication between the LIDAR chip and one or more amplifiers on an amplifier chip. Suitable attachment pads 338 include, but are not limited to, solder pads.

FIG. 10B is a perspective view of one embodiment of an amplifier chip. The illustrated amplifier chip is within the class of devices known as planar optical devices. The amplifier chip includes an amplifier waveguide 346 defined in a gain medium 340. Suitable gain media include, but are not limited to, InP, InGaAsP, and GaAs.

Trenches 374 extending into the gain medium 340 define a ridge 376 in the gain medium 340. The ridge 376 defines the amplifier waveguide 346. In some instances, the gain medium 340 includes one or more layers 341 in the ridge and/or extending across the ridge 376. The one or more layers 341 can be positioned between different regions of the gain medium 340. The region of the gain medium 340 above the one or more layers 341 can be the same as or different from the region of the gain medium 340 below the one or more layers 341. The layers can be selected to constrain light signals guided through the amplifier waveguide 346 to a particular location relative to the ridge 376. Each of the layers 341 can have a different composition of a material that includes or consists of two or more components of selected from a group consisting of In, P, Ga, and As. In one example, the gain medium 340 is InP and the one or more layers 341 each includes Ga and As in different ratios.

The amplifier waveguide 346 provides an optical pathway between a first facet 350 and the second facet 352. Although not shown, the first facet 350 and/or the second facet 352 can optionally include an anti-reflective coating. A suitable anti-reflective coating includes, but is not limited to, single-layer coatings such as silicon nitride or aluminum oxide, or multi-layer coatings that may contain silicon nitride, aluminum oxide, and/or silica.

The amplifier chip includes one or more attachment pads 354 that can be employed to immobilize the amplifier chip relative to the LIDAR chip. Suitable attachment pads 354 include, but are not limited to, solder pads.

The amplifier chip includes a first conductor 360 on the ridge and a second conductor 362 that is both under the gain medium and under the ridge 376. The first conductor 360 is in electrical communication with an attachment pad 354. Suitable methods for providing electrical communication between the first conductor 360 and the attachment pad 354 include, but are not limited to, conducting metal traces.

The amplifier chip also includes one or more alignment recesses 356. The dashed lines in FIG. 10B show the depth and shape of one of the alignment recesses 356.

FIG. 10C and FIG. 10D illustrates the LIDAR chip of FIG. 10A interfaced with the amplifier chip of FIG. 10B. FIG. 10C is a topview of the LIDAR system. FIG. 10D is a sideview of a cross section of the system taken through the waveguide 384 on the LIDAR chip and an amplifier waveguide 346 on the amplifier chip. For instance, the cross section of FIG. 10D can be taken a long a line extending through the brackets labeled B in FIG. 10C. FIG. 10C and FIG. 10D each includes dashed lines that illustrate features that are located behind other features in the system. For instance, FIG. 10C includes dashed lines showing the ridge 376 of the amplifier waveguide 346 even though the ridge 376 is located under the gain medium 340. Additionally, FIG. 10D includes dashed lines that illustrate the locations of the portion of the stops 332 and alignment recesses 356 located behind the ridge 376 of the amplifier waveguide 346. FIG. 10D also includes dashed lines that illustrate the location where the ridge 326 of waveguide 384 interfaces with the slab regions 328 that define the waveguide 384 also dashed lines that illustrate the location where the ridge 376 of the amplifier waveguide 346 interfaces with slab regions 374 of the amplifier chip.

The amplifier chip is positioned in the stop recess 330 on the LIDAR chip. The amplifier chip is positioned such that the ridge 376 of the amplifier waveguide 346 is located between the bottom of the amplifier chip and the base 21 of the LIDAR chip. Accordingly, the amplifier chip is inverted in the stop recess 330. Solder or other adhesive 358 contacts the attachment pads 338 on the bottom of the stop recess 330 and the attachment pads 354 on the amplifier chip. For instance, the solder or other adhesive 358 extends from an attachment pad 338 on the bottom of the stop recess 330 to an attachment pad 354 on the auxiliary device. Accordingly, the solder or other adhesive 358 immobilizes the auxiliary device relative to the LIDAR chip.

The facet 342 of the waveguide 384 is aligned with the first facet 350 of the amplifier waveguide 346 such that the waveguide 384 and the amplifier waveguide 346 can exchange light signals. As shown by the line labeled A, the system provides a horizontal transition path in that the direction that light signals travel between the LIDAR chip and the amplifier chip is parallel or is substantially parallel relative to an upper and/or lower surface of the base 21. A top of the first facet 350 of the amplifier waveguide 346 is at a level that is below the top of the facet 342 of the utility waveguide.

The one or more stops 332 on the LIDAR chip are each received within one of the alignment recesses 356 on the auxiliary device. The top of each stop 332 contacts the bottom of the alignment recess 356. As a result, the interaction between stops 332 and the bottom of the alignment recesses 356 prevent additional movement of the amplifier chip toward the LIDAR chip. In some instances, the auxiliary device rests on top of the stops 332.

As is evident from FIG. 10D, the first facet 350 of the amplifier waveguide 346 is vertically aligned with the facet 342 of the waveguide 384 on the LIDAR chip. As is evident from FIG. 10C, the first facet 350 of the amplifier waveguide 346 is horizontally aligned with the facet 342 of the waveguide 384 on the LIDAR chip. The horizontal alignment can be achieved by alignment of marks and/or features on the amplifier chip and the LIDAR chip.

The vertical alignment can be achieved by controlling the height of the stops 332 on the LIDAR chip. For instance, the cladding 334 on the base portion 336 of the stops 332 can be grown to the height that places the first facet 350 of the amplifier waveguide 346 at a particular height relative to the facet 342 of the waveguide 384 on the LIDAR chip. The desired cladding 334 thickness can be accurately achieved by using deposition techniques such as evaporation, plasma enhanced chemical vapor deposition (PECVD), and/or sputtering to deposit the one or more cladding layers. As a result, one or more cladding layers can be deposited on the base portion 336 of the stops 332 so as to form the stops 332 to a height that provides the desired vertical alignment. Suitable materials for layers of the cladding 334 include, but are not limited to, silica, silicon nitride, and polymers.

In FIG. 10D, the first facet 350 is spaced apart from the facet 342 by a distance labeled D. Since the amplifier waveguide is optically aligned with only one waveguide, the first facet 350 can be closer to the facet 342 than was possible with prior configurations. For instance, the distance between the first facet 350 and the facet 342 can be less than 5 μm, 3 μm, or 1 μm and/or greater than 0.0 μm. In FIG. 1D, the atmosphere in which the LIDAR chip is positioned is located in the gap between the first facet 350 and the facet 342; however, other gap materials can be positioned in the gap. For instance, a solid gap material can be positioned in the gap. Examples of suitable gap materials include, but are not limited to, epoxies and polymers.

The LIDAR chip includes electrical pathways 380 on the light-transmitting medium 324. The electrical pathways 380 can optically include contact pads and can be in electrical communication with the electronics. Although not illustrated, one of the electrical pathways 380 can be in electrical communication with the contact pad 354. Since the contact pad 354 is in electrical communication with the first conductor 360, the contact pad 354 provides electrical communication between the first conductor 360 and the electronics. Another one of the electrical pathways 380 can be in electrical communication with the second conductor 362. Suitable methods for providing electrical communication between the second conductor 362 and the electrical pathway 380 include, but are not limited to, wire bonding. Suitable electrical pathways 380 include, but are not limited to, metal traces.

The electronics can use the electrical pathways 380 to apply electrical energy to the portion of the amplifier between the first conductor 360 and the second conductor 362. The electronics can apply the electrical energy so as to drive an electrical current through the amplifier waveguide 346. The electrical current through the gain medium provides the amplification of light signals guided in the amplifier waveguide 346.

The amplifier chip of FIG. 10B through FIG. 10D can be modified to include multiple amplifiers to provide an amplifier chip that is suitable for use as the amplifier 304 in the 12 signal directing component 12 of FIG. 8. For instance, FIG. 11 is a perspective view of the amplifier chip of FIG. 10B through FIG. 10D modified to include two amplifier waveguides 346. The LIDAR chip includes a first conductor 360 on the ridge 376 of each amplifier waveguides 346 and a second conductor 362 that is both under the gain medium and under the ridges 376 of the amplifier waveguides 346. The electronics can amplify one of the amplifier waveguides by applying electrical energy between the first conductor 360 on the ridge of the selected amplifier waveguides 346 and the second conductor 362 while not applying electrical energy between the first conductor 360 on the ridge of any unselected amplifier waveguide(s) 346 and the second conductor 362. For instance, the electronics can amplify the light signal carried in a selected one of the amplifier waveguides 346 by driving an electrical current through the selected amplifier waveguides 346 and not driving an electrical current through any unselected amplifier waveguide(s).

The amplifier chip of FIG. 11 includes two amplifier waveguides but can be scaled up to include additional amplifier waveguides as shown in FIG. 8.

Although FIG. 8 and FIG. 11 illustrate multiple amplifier waveguides on a single amplifier chip, the signal directing component 12 of FIG. 8 can be constructed with each of the amplifier waveguides being on a different amplifier chip. For instance, a signal directing component 12 of FIG. 8 can be constructed with each of the amplifier waveguides included on a different amplifier chip constructed according to FIG. 11A through FIG. 11D.

In FIG. 10A through FIG. 10D, the amplifier chip is positioned in a stop recess 330 illustrated as being positioned at an edge of a LIDAR chip and accordingly being open to the edge of the LIDAR chip. As a result, the amplifier can serve as the amplifier 304 disclosed in the context of FIG. 8. However, the stop recess 330 can be centrally positioned on the LIDAR chip with the stop recess 330 having lateral sides that surround an interior of the stop recess. When recess is centrally positioned, the amplifier waveguide 346 can be aligned with two different waveguides or two different portions of the same waveguide as shown in FIG. 1 and FIG. 2. For instance, the second facet second facet 352 of the amplifier waveguide 346 can be aligned with a second facet (not shown) of the source waveguide in the same manner that the facet 342 of the waveguide 384 is aligned with the first facet 350 of the amplifier waveguide 346. As a result, the amplifier can serve as the amplifier 310 of FIG. 1 or FIG. 2.

As is evident in FIG. 1, FIG. 2, and FIG. 8, an amplifier waveguide(s) 346 can serve as a portion of one or more of the waveguides disclosed in the above LIDAR systems depending on the application of the amplifier. For instance, when the amplifier is used as shown in the LIDAR system of FIG. 1 or FIG. 2, the amplifier waveguide 346 serve as a portion of the source waveguide 11. When the amplifier is used as the amplifier 304 disclosed in the context of FIG. 8, the amplifier waveguide 346 can serve as a portion of a utility waveguide 13 as shown in FIG. 8. The amplifier waveguide 346 can serve as the entire utility waveguide 13. For instance, a signal directing component 12 constructed as disclosed in the context of FIG. 8, can have the amplifier waveguide 346 as the entire utility waveguide 13. As a result, the amplifier waveguide 346 can serve as at least portion of one or more of the waveguides disclosed in the above LIDAR systems

As disclosed in the context of the amplifier 304 in the signal directing component 12 of FIG. 8, the gain medium 340 can absorb light at the wavelength of the outgoing LIDAR signals in order to reduce the output from an unamplified utility waveguide 13. Suitable wavelengths for the outgoing LIDAR signals include, but are not limited to, wavelengths in a range of 1270 nm to 1650 nm. When the wavelength of the outgoing LIDAR signals is in a range of 1270 nm to 1650 nm, examples of gain media that absorb the outgoing LIDAR signals include, but are not limited to, III-V semiconductors.

As noted in the context of FIG. 6D, there are embodiments of the LIDAR system where the LIDAR system concurrently outputs the system output signals that each carries a different one of the channels. The LIDAR system concurrently outputs the system output signals carrying different channels when the LIDAR chip concurrently outputs each of the different LIDAR output signals. The LIDAR chip can concurrently output different LIDAR output signals when a signal splitter serves as the signal directing component 12 of FIG. 1 or as the optical switch 300 of FIG. 7. The signal splitter can be a wavelength independent splitter such as a directional coupler, optical coupler, y-junction, tapered coupler, a Multi-Mode Interference (MMI) device, and cascaded versions of these signal splitters. As a result, the outgoing LIDAR signals concurrently received by different utility waveguides 13 carry the same or substantially the same selection of wavelengths. The LIDAR chip can also be configured to concurrently output LIDAR output signals carrying different channels by operating the amplifier 304 of FIG. 8 such that the different outgoing LIDAR signals carried on different utility waveguides 13 are each concurrently amplified.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

A variety of optical switches that are suitable for use as one of the optical switches disclosed above can be constructed on planar device optical platforms such as silicon-on-insulator platforms. Examples of suitable optical switches for integration into a silicon-on-insulator platform include, but are not limited to, Mach-Zehnder interferometers, and cascaded Mach-Zehnder interferometers.

Suitable electronics 62 for use in the LIDAR system can include, but are not limited to, a controller that includes or consists of analog electrical circuits, digital electrical circuits, processors, microprocessors, digital signal processors (DSPs), Application Specific Integrated Circuits (ASICs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, a silicon-on-insulator wafer that includes the buried layer 320 between the substrate 322 and the light-transmitting medium 324 as shown in FIG. 9. The integrated on-chip components can be formed by using etching and masking techniques to define the features of the component in the light-transmitting medium 324. For instance, the slab regions 318 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 9 guides light signal through the light-transmitting medium 324 from the wafer. The integrated components can optionally include materials in addition to the materials that were present on the wafer. For instance, the integrated components can include reflective materials and/or a cladding.

The components on the LIDAR adapter need not be integrated. For instance, the components on the LIDAR adapter need not include materials from the base 100 and/or from the common mount. In some instances, all of the components on the LIDAR adapter and/or the isolator adapter are separate from the base 100 and/or from the common mount. For instance, the components on the LIDAR adapter can be constructed such that the light signals processed by the LIDAR adapter and/or the isolator adapter do not travel through any portion of the base 100 and/or the common mount.

Numeric labels such as first, second, third, etc. are used to distinguish different features and components and do not indicate sequence or existence of lower numbered features. For instance, a second component can exist without the presence of a first component and/or a third step can be performed before a first step.

Although the LIDAR systems are disclosed as having a light source 10 on the LIDAR chip, all or a portion of a suitable light source can be positioned off the LIDAR chip. For instance, the source waveguide 11 can terminate at a facet and light for the light source output signal can be generated by a light source off the LIDAR chip and can then enter the source waveguide 11 through the facet.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a beam steering mechanism configured to steer a system output signal in a field of view, the system output signal being output from the LIDAR system,
the beam steering mechanism including multiple utility waveguides that are each configured to output a LIDAR output signal, and
the beam steering mechanism including a redirection component configured to output a component output signal that includes light from the LIDAR output signal,
a direction that the component output signal travels away from the redirection component changing in response to a change in which one of the utility waveguides outputs the LIDAR output signal;
a signal steering mechanism configured to steer the system output signal on a two-dimensional path in the field of view.

2. The system of claim 1, wherein the beam steering mechanism includes optical amplifiers that are each positioned along one of the utility waveguides so as to amplify a power of the LIDAR output signal when the LIDAR output signal is output from the utility waveguide.

3. The system of claim 2, wherein each of the optical amplifiers includes an amplifier waveguide that serves as at least a portion of one of the utility waveguides,
each one of the amplifier waveguides receives a different utility signal,
electronics operate the optical amplifiers so as to amplify the utility signal carried on the utility waveguide that will output the LIDAR output signal while not amplifying the utility signal carried on one or more of the utility waveguides that will not output the LIDAR output signal.

4. The system of claim 3, wherein each of the amplifier waveguides are configured to absorb the utility signal when the electronics do not amplify the utility signal carried on the amplifier waveguide,
each of the amplifier waveguides being configured to absorb the utility signal such that a power level of the utility signal is reduced to less than 1% of the power level of the utility signal when the utility signal was received by the amplifier waveguide.

5. The system of claim 3, wherein a single layer of a gain medium is common to each of the amplifier waveguides.

6. The system of claim 1, wherein a circulator is configured to receive a circulator input signal that includes light from the LIDAR output signal and the circulator is configured to output a circulator output signal, the system output signal including light from the circulator output signal.

7. The system of claim 6, wherein a direction that the circulator output signal travels away from the circulator changing in response to a change in the utility waveguide that outputs the LIDAR output signal.

8. The system of claim 1, wherein a direction that the system output signal travels away from the LIDAR system changes in response to a change in which one of the utility waveguide outputs the LIDAR output signal.

9. A LIDAR system, comprising:
a signal steering mechanism configured to steer a system output signal in a field of view, the system output signal being output from the LIDAR system,
the signal steering mechanism including multiple utility waveguides that are each configured to guide a utility light signal and output a LIDAR output signal that includes light from the utility light signal,
each of the utility waveguides including an amplifier configured to amplify a power level of the utility light signal guided in the utility waveguide, and
a redirection component configured to output a component output signal that includes light from the LIDAR output signal,
a direction that the component output signal travels away from the redirection component changing in response to a change in which one of the amplifiers amplifies one of the utility light signals.

10. The system of claim 9, wherein a beam steering mechanism is configured to steer the system output signal in the field of view.

11. The system of claim 9, wherein a direction that the system output signal travels away from the LIDAR system changes in response to a change in which one of the amplifiers amplifies one of the utility light signals.

12. The system of claim 8, wherein each of the optical amplifiers includes an amplifier waveguide that serves as at least a portion of one of the utility waveguides,
each one of the amplifier waveguides receives a different utility signal,
electronics operate the optical amplifiers so as to amplify the utility signal carried on the utility waveguide that will output the LIDAR output signal while not amplifying the utility signal carried on one or more of the utility waveguides that will not output the LIDAR output signal.

13. The system of claim 12, wherein each of the amplifier waveguides are configured to absorb the utility signal when the electronics do not amplify the utility signal carried on the amplifier waveguide,
each of the amplifier waveguides being configured to absorb the utility signal such that a power level of the utility signal is reduced to less than 1% of the power level of the utility signal when the utility signal was received by the amplifier waveguide.

14. The system of claim 8, wherein a circulator is configured to receive a circulator input signal that includes light from the LIDAR output signal and the circulator is configured to output a circulator output signal, the system output signal including light from the circulator output signal.

15. The system of claim 14, wherein a direction that the circulator output signal travels away from the circulator changing in response to a change in a change in which one of the amplifiers amplifies one of the utility light signals.

16. A LIDAR system, comprising:
a beam steering mechanism and a signal steering mechanism that are each configured to steer a system output signal in a field of view, the system output signal being output from the LIDAR system,
a path of system output signal in the field of view having a contribution from the beam steering mechanism and the signal steering mechanism,
the contribution of the beam steering mechanism to the path being movement of the system output signal on a two-dimensional path back and forth across the field of view, and
the contribution of the signal steering mechanism to the path being movement of the system output signal transverse to the two-dimensional path contribution provided by the beam steering mechanism.

17. The system of claim 15, wherein the beam steering mechanism is a steerable mirror.

18. The system of claim 15, wherein the beam steering mechanism is configured to concurrently scan the system output signal on a slow axis and a fast axis,
the beam steering mechanism scanning the system output signal on the slow axis such that a direction that the system output signal travels away from the LIDAR system changes at a slow angular rate,
the beam steering mechanism scanning the system output signal on the slow axis such that a direction that the system output signal travels away from the LIDAR system changes at a fast angular rate,
a ratio of the fast angular rate to the slow angular rate being more than 2:1 and less than 200:1.

19. The system of claim 15, wherein the contribution of the beam steering mechanism to the path is movement of the system output signal in a zigzag pattern.

20. A system, comprising:
a LIDAR system configured to output multiple different system output signals that each travels away from the LIDAR system in a different direction and to receive system return signals that each carries light from a different one of the system output signals,
the LIDAR system configured to combine light from each of the system return signals with a reference signal so as to generate a signal beating at a beat frequency;
electronics that include an electrical demulitplexer that receives multiple different electrical data signals, each of the electrical data signals indicating one of the beat frequencies;
the electronics selecting a portion of the data signals and operating the electrical demultiplexer such that the electrical demulitplexer outputs the selected portion of the data signals; and
the electronics including a LIDAR data generator configured to calculate LIDAR data from the beat frequency indicated by the selected portion of data signals, the LIDAR data indicating a distance and/or a radial velocity between the LIDAR system and an object located outside of the LIAR system.
